(19) United States
(12) Patent Application Publication
(10) Pub. No.: US 2019/0147395 A1
(43) Pub. Date: May 16, 2019

(54) Storage Logistics Method

(71) Applicant: Würth International AG, Chur (CH)

(72) Inventor: Klaus Wittig, Öhringen-Cappel (DE)

(21) Appl. No.: 16/098,665

(22) PCT Filed: May 4, 2017
(86) PCT No.: PCT/EP2017/060607

§ 371 Date: Nov. 20, 2018

(30) Foreign Application Priority Data
May 4, 2016 (DE) 10 2016 207 713.9

(51) Int. Cl. G06Q 10/08; A47B 96/02; A47F 5/00

(52) U.S. Cl. CPC G06Q 10/087; G01G 3/12; A47F 5/005; A47B 96/021

(57) ABSTRACT

A storage system with a shelf unit having shelves arranged on top of each other, wherein each shelf is logically subdivided in compartments arranged side by side. A unique address is assigned to each compartment. A sensor system detects an occupancy of the compartments by spatially scanning to generate an occupancy information which indicates a degree of occupancy of the respective compartment. A data bus is connected to the sensor system and a communication device, wherein the storage system is configured to perform the following steps:
detecting an occupancy information of at least one compartment by the sensor system,
transmitting the occupancy information having the address assigned to the compartment, from which the occupancy information has been measured, from the sensor system to the communication device via the data bus, and
establishing a network connection by the communication device to transmit occupancy information to a server or control information to the storage system in a unidirectional or bidirectional communication.

### CROSS-REFERENCE TO RELATED APPLICATIONS

The present application is a national phase application derived from the international patent application no. PCT/EP2017/060607, which was filed on May 4, 2017 and which claimed the priority including the benefit of the filing date of the German patent application no. DE 10 2016 207 713.9 filed on May 4, 2016, both of which are incorporated herein by reference in their entirety.

### TECHNICAL FIELD

The invention relates to a storage system having at least one shelf unit, wherein the shelf unit has plural shelves arranged on top of each other, wherein each shelf is logically subdivided in plural compartments arranged side by side. The invention relates further to a method for setting up such a storage system.

Technological Background

In order to satisfy the requirements of a modern and thus demanding logistics, it is necessary nowadays to make the storage systems used for this purpose intelligent, and to integrate them in superordinate total systems.

Generally, some approaches for automated storage systems having automatic detection devices are already known.

DE 10 2007 017 207 A1 describes a sensor for a detection of an occupancy, and discloses a drawer having a standard part of foamed material and recesses for receiving tools. A sensor formed as a reflected-light barrier is located at the bottom of a recess and comprises a light transmitter as well as a receiver arranged in the immediate vicinity. As a function of whether a tool is located in the recess or not, the emitted light is reflected or not, such that the receiver generates a signal only, if a tool is present in the recess.

DE 197 14 799 C2 shows a device for storing units of goods having a matrix of sensors arranged at the bottom of a goods shelf and corresponding signal lines, wherein in the area of the goods shelf the signal lines are formed by a conductor board stripe, on which also the sensors are mounted, wherein the sensors are pressure sensors, capacitive/inductive sensors or mechanical switches.

EP 1 217 345 A1 shows a system for controlling the flow of goods of different articles from plural suppliers to one usage site, wherein a storage is conceived at the usage site, which storage automatically detects the necessity to re-fill the shelf.

DE 698 27 454 T2 shows a method for managing a storage system having containers, wherein refilling of the containers is prompted automatically.

DE 20 2014 004 232 U1 shows a shelf unit for goods for the self-service withdrawal of bakery products. The shelf unit for goods has a stock compartment and at least one light barrier. This allows to detect the filling state of the stock compartment in the area of the light barrier.

EP 2 178 035 A1 discloses a method and an arrangement for an empty space measurement of storage spaces or transport spaces. A storage space or transport space is subdivided in plural partial areas. A distance measurement is performed in the partial areas. The results of the measurement are transmitted to a central entity. The central entity can process the results of the measurement, such that information on the occupancy of the storage space or transport space can be determined.

WO 2005/088494 A1 relates to a storage system having at least one receptacle for storing goods. The storage system has a gravimetric sensor element for detecting the goods. The storage system may have additional sensor types for detecting the goods.

DE 10 2004 035 819 A1 discloses a method for automatic detection of storage goods in a store-room. Herein, each single article that is stored in the store-room is provided with a transponder. Object-related data are transmitted from the transponder to a reading device and are registered by a storage management computer.

In addition to this, further solutions are known, which detect the weight by force sensors, such as e.g. weighing cells or resistance strain gauges, and thus detect an occupancy. Optical systems are known, in which cameras record images, and the image data are evaluated in respect of an occupancy detection.

### SUMMARY

There may be a need to provide an improved storage system as well as methods for setting up and for operating such a storage system, which enable an improved setting up of the storage system.

The invention provides a storage system according to the appended independent claim 1, a method according to the appended independent claim 17 for setting up such a storage system, and a method according to the appended independent claim 19 for operating such a storage system. Preferred embodiments of the invention are indicated in the dependent patent claims.

Exemplary embodiments of the invention are particularly advantageous, because an automatic measurement of the stocks (or inventories) in the individual compartments of the storage system can be effected. If the occupancy information shows a too low stock in a compartment, the communication device or the server can prompt a repeat order (or re-order) of the respective articles. These can subsequently be sorted into the respective compartments, wherein a measurement of the new stocks can be effected by the sensor assemblies. Thus, a simplified stock-keeping is possible. In addition, the occupancy information can for example be requested via the communication device or the server, such that also a remote request can be effected whether sufficient stocks of individual articles are present in the compartments.

According to an exemplary embodiment of the invention, there is provided a storage system having at least one shelf unit, wherein the shelf unit has plural shelves arranged on top of each other. Each shelf is logically subdivided in plural compartments arranged side by side, wherein a unique address is assigned to each of the compartments. Furthermore, the storage system has a sensor system for detecting an occupancy of the compartments, wherein the sensor system is configured to spatially scan the occupancy of one of the compartments so as to generate an occupancy information, which indicates a degree of occupancy of the respective compartments, as well as a data bus, which is connected to the sensor system and a communication device. The storage system is configured to perform the following steps:
detecting (or measuring) in each case an occupancy information of the compartments by the sensor system,
transmitting the occupancy information with the address assigned to the compartment, from which the occupancy information has been detected, from the sensor system to the communication device via the data bus,
establishing a network connection by the communication device so as to transmit occupancy information to a server or control information to the storage system in a unidirectional or bidirectional communication.

### OVERVIEW OF EMBODIMENTS

The shelf unit may concern a shelf unit having inclined shelves, and the shelves may have a slope in the direction towards a withdrawal side of the shelf unit having inclined shelves. In a shelf unit having inclined shelves, the shelves have a slope in a filling and/or withdrawal direction, such that the articles stored in the compartments slide down in the withdrawal direction automatically after the withdrawal of an article. Thus, the articles lie without gap against each other. The use of a sensor system in such shelf units having inclined shelves is particularly advantageous, because a detection (or measurement) of the stock (or inventory) is possible with few sensors, because no possibly present free spaces between the articles need to be detected. It is only necessary to detect the position of the last article. If the length of the individual articles and/or the number of articles per unit length is known, the number of articles in the respective compartment can be determined in this way. For example, the length of the individual articles can be known already, or this is determined during the setting up of the shelf system and is stored. If the position of the last article is known upon a filling with the minimum quantity, it is for example also sufficient to inquire only the sensor element assigned to this position so as to check whether a minimum quantity of the respective article is present. For example, during the setting up of the shelf system, the shelf system can be filled with the minimum quantity, and the position of the last sensor, which indicates an occupancy, and/or the position of the first sensor element, which indicates no occupancy, can be detected.

The sensor system has for example plural sensor assemblies, and each one of the sensor assemblies is assigned to one of the compartments, wherein a sensor assembly to its part has a number of sensor elements arranged in a longitudinal direction of the sensor assembly. The assignment of the sensor assemblies to the compartments can simplify the control and/or the setting up of the storage system. The sensor elements arranged in the longitudinal direction can be arranged in the longitudinal direction of a compartment, for example in a shelf unit having inclined shelves in the withdrawal direction, such that a simple detection of the stock in a compartment can be effected.

In particular, each sensor assembly can be assigned precisely to one compartment, and the longitudinal direction of the sensor assembly runs in the direction of the slope of the compartments.

A sensor assembly can have a stripe-shaped, flexible or rigid conductor plate as a carrier. The conductor plate can be adapted to the shape and/or the geometry of the respective compartment.

A sensor assembly can be fixed to a lower side of a shelf, by which the compartment assigned to the respective sensor assembly is formed. Thereby, a space-saving arrangement of the sensor assembly is possible.

The storage system may further have a control electronics for each of the sensor assemblies, wherein the control electronics is configured to connect the sensor assembly t the data bus as well as to output the address assigned to the compartment and the occupancy information onto the data bus.

For example, at least one optical signalling means is uniquely assigned to each of the compartments, wherein the optical signalling means is connected to the data bus so as to receive via the data bus a signal for an optical indexing of the compartment and to realize the optical indexing. For example, a compartment, which is to be filled up, can be indexed by the signalling means.

The storage system can be configured to store a stock-taking point in time and to perform an automatic stock-taking upon reaching the stock-taking point in time. The determining (or measuring) of the stock (or inventory) of all compartments can require a specific time as a function of the size of the storage system, wherein it may be desired that no articles are withdrawn or sorted in during the determining of the stock. The point in time for the stock-taking can be selected such that no withdrawal or sorting in into the storage system occurs during the stock-taking, for example at night time.

For example, an occupancy plan is stored in the communication device, in which occupancy plan an assignment of goods types respectively to one or plural addresses and/or compartments and a threshold value for the occupancy quantity of goods of a respective goods type are stored. The communication device can be configured such that the quantity of goods of each goods type placed into stock in the storage system can be determined from the occupancy information received via the data bus and the respective assigned addresses, that the determined quantity of goods of each goods type is compared with the quantity threshold value assigned to this goods type, and that a signal can be sent, if the determined quantity of goods of this goods type falls below the quantity threshold value assigned to it. In this way, it can be ensured that a sufficient quantity of the articles stored in the compartments is always present.

According to embodiments of the invention, a remote maintenance program module can be installed on the communication device, which is addressable via the network and which can perform maintenance operations directly on the storage system. The remote maintenance program module is configured for example such that upon (or in response to) the receipt of a command via the network the sensor system is activated such that the occupancy information of a compartment specified by the indication of a corresponding address in the command is detected (or measured), and based on the occupancy information an occupancy information signal is generated, which is sent via the network.

The communication device can dynamically store occupancy information of the storage system, such that in the case of a system failure, the occupancy information can be restored at any time and can be used again upon a new system availability.

For example, the communication device is configured to connect to a computer via a local connection so as to visualize an occupancy plan stored in the communication device on a user interface of the computer.

The communication device can have a setup mode, wherein an occupancy of the storage system, which is detected (or measured) by the sensor system in the setup mode, can be stored as an occupancy plan, wherein the occupancy plan comprises in particular the goods type assigned to each one of the compartments and an occupancy threshold value assigned to this goods type, which threshold value is given by the occupancy detected by the sensor system.

The storage system may further have a hand-held scanner for optically determining (or measuring) an optically readable code, wherein each one of the compartments carries an optically readable code indicating the respective address, wherein the communication device is configured such that the assignment of a goods type to one or plural of the compartments is effected in that the communication device receives from the hand-held scanner an optically measured address and a goods type assigned to the optically measured address.

For example, the hand-held scanner is configured wirelessly and has a wireless communication interface for the communication with the communication device.

The sensor system may have one sensor assembly per compartment as a flexible, stripe-shaped conductor board.

The sensor assemblies can be fixed respectively to the lower side of a shelf, such that the signal transducers of one of the sensor assemblies can emit a signal in the direction towards the upper side of the shelf located respectively one level lower, and the signal receivers of one of the sensor assemblies can receive a signal from the shelf located respectively one level above through openings located in the shelf. Thus, only respectively one sensor assembly has to be installed in order to install a group of signal transducers as well as a group of signal receivers. Thereby, the installation effort is reduced and the constructional height of the sensor assembly is reduced. The signal direction from the signal transducer to the signal receiver thus runs from the top downwardly. However, the signal direction can run from the bottom upwardly, by arranging the signal receivers at the upper side of the compartment and the signal transducers at the lower side of a compartment.

The signal transducers and the signal receivers of a sensor assembly can be arranged pairwisely on the conductor board, such that a signal transmitted by one of the signal transducers can be received from a signal receiver of the same pair. Thereby, the signal transmitted from the signal transducer can be received simpler by the signal receiver, if the distance between the signal receiver and the signal transducer is shorter and/or the signal does not have to traverse the receiving space of the compartment. In particular, the signal can be configured weaker, such that the danger of an influencing by the signals of neighbouring signal transducers is lower. A further advantage consists in that no mutual alignment of the signal receiver and the signal transducer in the compartment has to be effected. The alignment is effected already by the arrangement on the conductor board. This has the advantage that a greater manufacturing tolerance is possible in the manufacturing of the shelf unit, because no alignment to each other of the shelves and/or of the sensor assemblies at the shelves is required.

For example, the signal transducers and the signal receivers of a sensor assembly can be arranged pairwisely on the same conductor board, in particular directly adjacently (or neighbouring), wherein the pairwisely arranged signal transducers and signal receivers are assigned respectively to one opening located in the shelf, such that a signal emitted by one of the signal transducers can be sent through the opening and be received [through the opening] by a signal receiver of the same pair.

In particular, the signal receiver and the signal transducer can be arranged adjacently (or neighbouringly) on the conductor board. For example, the signal receiver is arranged annularly around the signal transducer, such that it can receive the signal emitted by the signal transducer independently from the emitting direction.

The signal transducer, the signal receiver and/or conductor paths for interconnecting the signal transducers and the signal receivers are printed for example together with the data bus on the conductor board.

The shelves can have plural openings in the filling direction of the compartments, in particular in the direction of the slope so as to enable a signal receipt and/or a signal transmission by the sensor system, wherein the sensor assemblies of the sensor system are arranged underneath the shelves, and are covered with a film, which covers the openings, and which is applied in the filling direction on an upper side of the shelf. The film protects the sensor assembly from contamination, and in addition provides a plane area on the shelf. A sliding area can be formed by the plane film for example in shelf units having inclined shelves, which sliding area enables a better sliding-down of the articles within a compartment.

The film may concern a plastic film, in particular a PVC film, wherein the plastic film is transparent in particular in the range of a frequency of the signal receipt and/or the signal emission.

According to another exemplary embodiment of the invention, there is further provided a method for setting up a storage system, the method having the following steps:
switching the communication device in a setup mode,
occupying the compartment of the storage system according to a predetermined occupancy plan with minimum stock quantities, below which repeat orders (or re-orders) are to be triggered,
detecting (or measuring, or capturing) the minimum stock quantities by the sensor system and storing in the communication device,
completing the occupancy to the nominal stock in the storage system.

The assignment of a goods type to one of the compartments can be effected by a hand-held scanner.

The hand-held scanner has for example a wireless communication interface to the communication device so as to transmit an assignment signal for assigning the goods type to one of the compartments to the communication device.

According to still another exemplary embodiment of the invention there is further provided a method for operating a storage system, the method having the following steps:
detecting (or measuring, or capturing) the occupancy information of at least one of the compartments,
comparing the detected occupancy information with a stored occupancy plan by the communication device,
if a discrepancy between the detected occupancy information and the occupancy plan is detected by the communication device, generating a false occupancy signal by the communication device, and sending the false occupancy signal via the data bus to the address of the very sensor assembly, from which the occupancy information has been detected.

The optical signalling means can be connected to the data bus via the sensor assembly, and the electronic control of the sensor assembly, which may receive the false occupancy signal via the data bus from the communication device, can activate the optical signalling means of the respective sensor assembly for outputting the false occupancy signal.

In the following, further features of possible embodiments are described, whereby the features are combinable among each other and with the features indicated above.

The sensor assembly may have a carrier element having at least two sensor elements, wherein the sensor elements may be arranged on different outer surfaces of the carrier element.

It may be preferred that the carrier element may have an angled, preferably a triangular or a quadrangular, in particular a quadratic or rectangular, cross-section.

It is proposed that the carrier element may be formed angledly, circularly, cross-shapedly, y-shapedly, strip-shapedly, grid-shapedly, meander-shapedly and/or star-shapedly.

It is further proposed that the carrier element may be rigid, flexible or semi-flexible, or may have at least two rigid, flexible or semi-flexible sections, which may be connected to each other.

The carrier element may be constructed from a film (or foil), or of plural layers of same or different films and/or materials.

Furthermore, it may be provided that the carrier element is formed at least partially as a printed circuit board having conductor paths, or may have at least electrical conductor structures for an electrical contacting and/or transmission of the signals of the sensor elements and/or further electrical and/or electronical components and/or for a connection to a data bus and/or to a power supply and/or for a connection to at least one further sensor assembly.

In a further developed embodiment, it is proposed that a sensor element may be formed respectively as a signal transducing device (or signal transducer) or as a signal receiving device (or signal receiver).

It is preferable that a test signal transducer may be associated to (or provided adjacent to) a signal receiver such that the signal receiver can detect directly or indirectly signals of the associated test signal transducer.

Furthermore, it is proposed that at least first sensor elements of a first outer surface of the sensor assembly may be formed complementary to the at least second sensor element of a second outer surface of the sensor assembly, in particular that the first sensor element may be formed as a signal transducer and the second sensor element may be formed as a signal receiver, or that the first sensor element may be formed as a signal receiver and the second sensor element may be formed as a signal transducer.

In a further developed embodiment, it is proposed that at least two sensor elements may be formed complementary with respect to each other and may be arranged at respectively mutually opposing outer surfaces of the carrier element, in particular that a first sensor element may be formed on a first outer surface as a signal transducer and the second sensor element may be formed on a second outer surface opposite to the first outer surface as a signal receiver, or that a first sensor element may be formed on a first outer surface as a signal receiver and the second sensor element may be formed on a second outer surface, opposite to the first outer surface, as a signal transducer.

It is advantageous that the sensor elements may be arranged at least partially integrated on or in an outer surface of the carrier element.

It can be provided that the signal, which may be emitted by at least one signal transducer and received by at least one signal receiver, may be a magnetic signal, an electromagnetic signal, or an acoustic signal.

In a further developed embodiment, it is proposed that the signal transducer may have at least an LED, an OLED or a piezo-crystal, or may be formed of an array of [one of] these elements.

In particular, it is proposed, that IR light may be emitted from at least one signal transducer.

Furthermore, it is proposed that at least one sensor element and/or at least one conductor path may be printed.

It is further proposed that a control electronics may be mounted on the carrier, wherein the control electronics may identify distinctly (or uniquely) the sensor assembly as opposed to other sensor assemblies.

It is further proposed that the control electronics may activate the sensor elements, and may register, may further process, and may transmit the data signals of the sensor elements.

In a further developed embodiment, it is proposed that the signal, which may be generated by the control electronics and emitted by the signal transducer, may be variable in terms of its frequency and/or its intensity.

In a still further developed embodiment it is proposed that the emitted signal may be clocked (or synchronized) such that the signal may be coded.

It is further proposed that an operation state related to the sensor elements that may be present can be activated or inquired (or prompted) by the control electronics individually, group-wisely or all at once, in particular, that a signal transducer may output a signal, or that a signal receiver may be inquired as to whether it receives a signal.

It is further proposed that the carrier element may have more than two, preferably a plurality of, sensor elements on at least one outer surface, which [sensor elements] may be arranged in a defined manner with respect to each other, preferably on at least one line or in at least one row.

In a further developed embodiment, it is proposed that sensor elements for different types of signals may be grouped jointly, and/or may be arranged alternatingly, on an outer surface of the carrier element.

In a still further developed embodiment it is proposed that only sensor elements of one type of the devices may be, respectively, arranged on one outer surface, in particular that the sensor elements arranged on an outer surface may be formed respectively only as signal transducing devices or respectively only as signal receiving devices.

It may be provided that the signal transducing devices and the signal receiving devices may be grouped jointly, and/or may be arranged alternatingly, on an outer surface of the carrier element.

It is further proposed that a marking may be present for a later positioning and/or alignment of the sensor assembly.

It is further proposed that a fixing device may be present for a later positioning and/or fixing of the sensor assembly.

It is further proposed that the carrier element may have an adhesion surface on at least one outer surface.

In a further developed embodiment, it can be provided that the adhesion surface may be covered at least temporally with a detachable covering foil (or film).

Furthermore, a sensor system for an occupancy detection with at least two sensor assemblies may be provided, wherein the sensor assemblies may be arranged in at least one position such that they may comprise at least partially a surveillance space, and such that an emitted signal of at least one signal transducer of a first sensor assembly may be detectable in at least one occupancy state by at least one signal receiver of a second sensor assembly, so that a received signal may be interpreted as a first occupancy state, and a sent, but not received, signal may be interpreted as a second occupancy state.

In a further developed embodiment, it is proposed that the sensor assemblies may be arranged in at least one position relative to each other such that at least a respective one of their outer surfaces may face another one at least partially, and that at least one sensor element may be arranged on each one of the at least partially facing outer surfaces, which sensor elements may be, respectively, complementary to each other, in particular that the at least first sensor element may be formed as a signal transducing device and that the at least second sensor element may be formed as a signal receiving device, or that the at least first sensor element may be formed as a signal receiving device and that the at least second sensor element may be formed as a signal transducing device.

It is further proposed that at least one further sensor element may be arranged for at least one of the sensor assemblies on at least one of the outer surfaces that does not face another sensor assembly.

It is further proposed that at least one further sensor element may be arranged for at least one of the sensor assemblies on the outer surface that faces away from another sensor assembly.

In a further developed embodiment, it is proposed that the at least one further sensor element may be complementary to the type of the at least one sensor element on the outer surface that faces the at least one other sensor assembly, in particular that the sensor element may be formed as a signal transducing device and the sensor element is formed as a signal receiving device, or that the sensor element may be formed as a signal receiving device and the sensor element is formed as a signal transducing device.

In a still further developed embodiment, it is proposed that, in relation to the arrangement of the at least two sensor assemblies, the sensor elements of respectively one type of the devices may all have the same orientation, in particular that all signal transducing devices may be oriented in a first direction and all signal receiving devices may be oriented in a second direction.

The first direction and the second direction may be oriented opposite to each other.

It is further proposed that at least two, preferably a plurality of, sensor elements may be arranged on an outer surface of a sensor assembly or of a section of a sensor assembly having a sensor element.

It is further proposed that the sensor elements of two neighbouring sensor assemblies may be, respectively, positioned approximately on a common axis.

Furthermore, it is proposed that only sensor elements of one type may be arranged on the mutually facing outer surfaces of a sensor assembly or of a section of a sensor assembly having a sensor element, in particular that sensor elements arranged on a respective outer surface may be formed only as signal transducing devices or only as signal receiving devices.

In a further developed embodiment, it is proposed that the sensor elements may be spaced at a distance to each other such that at least one pair of sensor elements may be present for a smallest unit to be measured, in particular that at least one signal transducing device and at least one signal receiving device may be present, respectively, for a smallest unit to be measured, preferably that plural signal transducing devices and plural signal receiving devices may be present for a smallest unit to be measured.

Furthermore, it is proposed that a control electronics may coordinate pairwisely or groupwisely (or in a pairwise manner or in a groupwise manner) sensor elements, which may respectively function complementary and may act with each other, of the at least two sensor assemblies or of different sensor assemblies, in particular may synchronize [them] with each other, and in particular may control the transmission and the detection of signals.

In a further developed embodiment, it is proposed that the surveillance space may be subdivided into at least two partial sections (or sub-sections), wherein the partial sections may be, respectively, managed logically by the control electronics, wherein in particular at least one signal transducer and one signal receiver or a group of sensor elements, which may function complementary and act with each other, may be assigned to a first partial section, and at least one further signal transducer and one further signal receiver or a group of further sensor elements, which may function complementary and act with each other, may be assigned to a further partial section.

In a still further developed embodiment, it is proposed that the control electronics may evaluate the detected signals further, and may relay the signals and/or the determined occupancy states to a superordinate storing device or to a superordinate control unit on the basis a communication device.

Furthermore, a storing device for storing and managing storing good, in particular piece good and/or bulk good, may be provided, wherein the device may have at least one surveillance space for the receiving of the storage good, and a sensor system.

It is proposed that the occupancy state and/or the degree of filling of the surveillance space may be monitored (or surveilled) by at least two approximately opposing sensor elements, wherein in at least one occupancy state an emitted signal S of at least one signal transducer of a first sensor assembly may be detectable by at least one signal receiver of a second sensor assembly, such that a received signal can be interpreted as a first occupancy state, and a sent, but not received, signal or a dampedly received signal can be interpreted as a second occupancy state, wherein the combination of plural occupancy states can be interpreted as a degree of filling.

Furthermore, it is proposed that the surveillance space may be at least partially defined (or delimited) by at least two delimitation elements or by at least two sections of a delimitation element, wherein the delimitation elements or the sections may approximately oppose each other at least partially, respectively, with at least one outer surface.

It is further proposed that at least one sensor assembly may be arranged, respectively, on a delimitation element, or, respectively, on a section.

In a further developed embodiment, it can be provided that at least one sensor assembly may be arranged on an outer surface of a delimitation element, which outer surface may face the surveillance space.

In a still further developed embodiment, it is proposed that at least one sensor assembly may be arranged on the outer surface of the respective delimitation element, which outer surface may face away from the surveillance space.

In a still further developed embodiment, it is proposed that at least one sensor assembly may be at least partially integrated in the respective delimitation element at least on one side of the surveillance space.

It may also be provided that the delimitation element may have has at least one signal opening, so that the at least one integrated sensor assembly or the at least one sensor assembly, which may be arranged on the outer surface facing away from the surveillance space, can send a signal to at least one further sensor assembly through the signal opening and/or can receive a signal from at least one further sensor assembly through the signal opening.

This embodiment may contribute relevantly to the possibility that sensor assemblies having sensors can be used on mutually opposing outer surfaces of a carrier, because, thereby, sensors of both sides can be involved in the process and can interact with other sensors. On the other hand, thereby, it may also be possible to save the half of the otherwise necessary sensor assemblies, because, with this embodiment, sensors may obtain access on two sides, and one side, respectively, may not be hindered by a usually impenetrable delimitation element, and/or otherwise only sensors, which may be populated (or equipped) on one side, may be used.

In a further developed embodiment, it can be provided that the signal opening may be filled up at least partially with a sensor element and/or that the signal opening may be at least partially covered and/or filled up with a material that may be penetrable for the signal.

Furthermore, it can be provided that at least one delimitation element may have a device or a recess for an at least partial incorporation of at least one sensor assembly.

In particular, it can be further provided that the device or recess may have an opening for inserting a delimitation element on at least one outer surface.

Furthermore, it can be provided that at least one sensor assembly may have fixed to at least one delimitation element in a defined position with respect to a reference point of the storage device and/or of the delimitation element and/or of at least one further sensor assembly.

It is proposed that at least one sensor assembly may have glued (or fixed) to at least one delimitation element.

It is further proposed that at least two, preferably a plurality of, sensor assemblies may be arranged approximately parallel to each other on a delimitation element, wherein the sensor elements that may be arranged in a plane may form a sensor matrix.

At least one separating element, preferably plural separating elements, may be arranged on, respectively, at least two delimitation elements, which may oppose each other and thus may be aligned approximately parallel to each other, wherein the separating elements may run transversely to the delimitation elements, such that at least two, preferably a plurality of, surveillance spaces may be formed.

In a further developed embodiment, it is proposed that at least one fixing device for at least one separating element may be present on at least one delimitation element on at least one outer surface.

In a still further developed embodiment, it is proposed that a plurality of fixing devices may be arranged on at least one side of a delimitation element, such that a variable sub-divisioning of the surveillance space may be possible.

Furthermore, it is proposed that at least one signal transducing device and one signal receiving device may be assigned to each surveillance space.

In particular, it is proposed that the storing device may be a shelf unit (or rack), and at least one first delimitation element may form a shelf.

Furthermore, it is proposed that further delimitation elements, respectively, may form further shelf unit planes in the shelf unit, wherein the space between two respective shelf unit planes may form at least one surveillance space.

Furthermore, it is proposed that the at least one sensor assembly may be arranged, according to the gravity, underneath the respective shelf of a shelf unit plane.

Sensor elements of different shelf unit planes may be aligned, respectively according to their respective position in the sensor assembly approximately on a common axis, wherein the axis may run vertically according to gravity.

Furthermore, it is proposed that sensor elements of different shelf unit planes may be oriented, respectively, according to their respective type, in only one direction, in particular that all signal transducing devices of different planes may be oriented only in a first direction and that all signal receiving devices of different planes may be oriented only in a second direction.

In a further developed embodiment, it is proposed that all signal transducing devices may be, according to gravitation, oriented from the top to the bottom, and all signal receiving devices may be oriented oppositely from the bottom to the top.

Furthermore, it is proposed that the shelf of respectively one shelf unit plane may have, in at least one direction, a slope (or an inclination) with respect to the horizontal plane in space.

In particular, it is proposed that the storage device may be a cupboard having at least one drawer, wherein at least two mutually opposing side walls of the drawer, as delimitation elements, at least partially may enclose a surveillance space.

In a still further developed embodiment, it is proposed that at least one sensor assembly may be integrated in at least one delimitation element forming a side wall.

Sensor elements of different delimitation elements may be oriented, respectively, according to their respective position on the sensor assembly approximately on a common axis, wherein the axis may run approximately horizontally and transverse to the gravitation F.

It is further proposed that sensor elements of different delimitation elements may be oriented, respectively, according to their respective type, in only one direction, in particular that all signal transducing devices of different delimitation elements may be oriented only in a first direction and that all signal receiving devices of different delimitation elements may be oriented only in a second direction.

Furthermore, it is proposed that all signal transducing devices may be oriented from the backside wall to the frontside wall according to the pulling-out direction of the drawer, and that all signal receiving devices may be oriented oppositely from the frontside wall to the backside wall.

Furthermore, it is proposed that at least one further delimitation element, which may be arranged transverse to the pulling-out direction of the drawer, may be provided.

Furthermore, it is proposed that at least one separating element, which may be arranged parallel to the pulling-out direction of the drawer, may be provided.

In a further developed embodiment, it is proposed that the drawer may have a drawer plug connector, which may connect the drawer at least in the closed state electrically to a power supply and/or to a data line in the corpus of the cupboard.

Furthermore, it is proposed that a control unit inquires at least one occupancy state of at least one surveillance space or of a part of a sub-divided surveillance space or of a partial section, and evaluates the result and/or transmits this further to a superordinate management system.

Furthermore, it is proposed that the control unit may manage logically at least respectively two co-operating sensor elements of at least two different sensor assemblies of the different at least subsets of co-operating sensor matrices, and thus may define a logical partial section, which may extend in a plane along an extension direction of a first sensor assembly and/or transversely to the extension direction of a first sensor assembly over at least one further sensor assembly arranged in parallel.

In a further developed embodiment, it is proposed that at least one partial section (or sub-section) may correspond to precisely one unit of a storage good to be stored.

In a still further developed embodiment, it is proposed that at least one logical partial section may correspond to at least one arrangement of delimitation elements and/or separating elements, in particular may correspond to the size of at least one partial section formed by delimitation elements and/or separating elements.

In a still further developed embodiment, it is proposed that the control unit, during an initialization process, may detect the partial sections on the basis of the arrangement of the delimitation elements and/or the separating elements among each other, and correspondingly may define the surveillance space into its logical partial sections, and may store [them] in the management system.

Further features, details and advantages of the invention follow from the claims of protection, the wording of which is made contents of the description by reference. The features, which are mentioned above and which are still to be explained in the following, are usable not only in the respectively indicated combination, but also in other combinations or in an island position (or taken alone), without leaving the framework of the present invention.

### BRIEF DESCRIPTION OF THE DRAWINGS

Embodiments and examples of the invention are represented in the drawings and are explained in more detail in the following description. The drawings show the following:

FIG. 1: a perspective view of a sensor assembly;

FIG. 2: different views of a sensor assembly;

FIG. 3: perspective views of possible cross-sections of a sensor assembly;

FIG. 4: top views of possible shapes of a sensor assembly;

FIG. 5: a perspective view of a sensor assembly;

FIG. 6: a perspective view of a sensor assembly;

FIG. 7: a front view of a sensor assembly;

FIG. 8: a front view of a sensor assembly;

FIG. 8a: a front view of a sensor assembly;

FIG. 9: a front view of a sensor assembly with a partial section;

FIG. 10: a side view of a sensor assembly;

FIG. 11: a diagram of possible signals;

FIG. 12: a side view of a sensor assembly;

FIG. 13: a top view of a sensor assembly;

FIG. 14: a schematic representation of a sensor system;

FIG. 15: a side view of a sensor system;

FIG. 16: a side view of a sensor system;

FIG. 17: a side view of a sensor system;

FIG. 18: schematic representations of a storage device;

FIG. 19: schematic representations of a storage device having different occupancy states;

FIG. 20: side views relating to an arrangement of a sensor assembly at a storage device;

FIG. 21: a side view of delimitation elements;

FIG. 22: a side view and section of a delimitation element;

FIG. 23: perspective representations of delimitation elements;

FIG. 24: perspective representations of delimitation elements;

FIG. 25: a perspective representation of a delimitation element;

FIG. 26: a perspective representation of a delimitation element;

FIG. 27: a perspective representation of a delimitation element;

FIG. 28: a perspective representation as well as top view and detailed view of a delimitation element;

FIG. 29: a perspective representation of a shelf;

FIG. 30: perspective representation of a shelf unit;

FIG. 31: a shelf and section through plural shelves;

FIG. 32: a schematic representation of a shelf unit system,

FIG. 33: a block diagram of the shelf unit system of FIG. 32,

FIG. 34: a flow diagram of the setting up of the shelf unit system of FIGS. 32 and 33, and

FIG. 35: a flow diagram of the operation of the shelf unit system of FIGS. 32 and 33.

### DETAILED DESCRIPTION OF ILLUSTRATED EMBODIMENTS

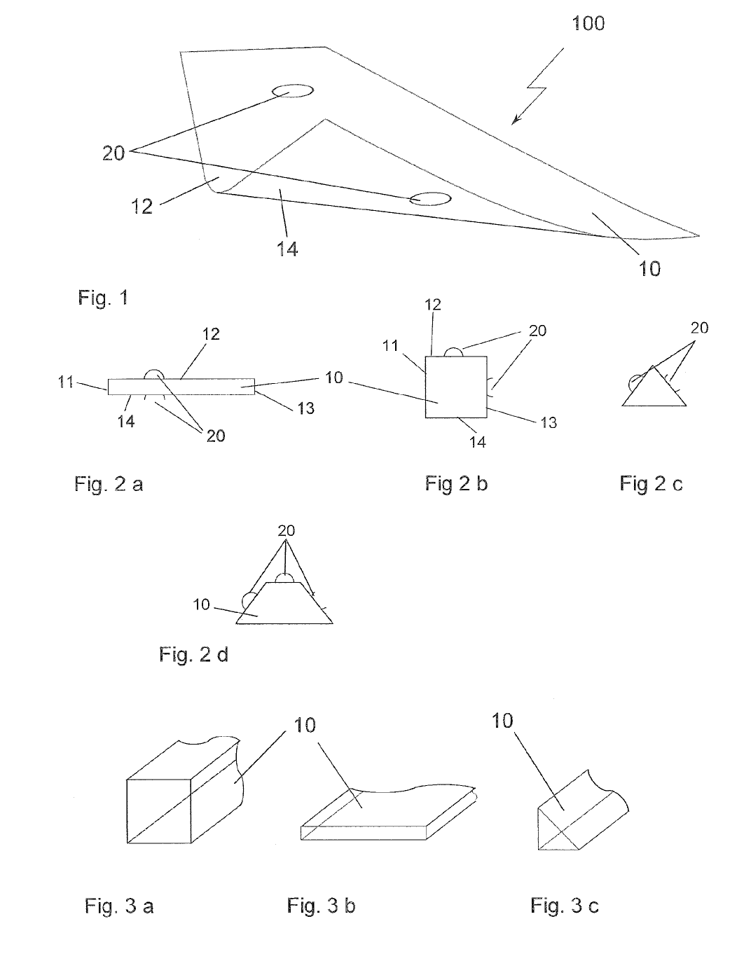

FIG. 1 shows a perspective view of a sensor assembly 100, which, in an embodiment according to the invention, may be manufactured with a carrier (or supporting device) 10 made of a flexible material. The view is obliquely from the above onto the front left corner, which is represented lifted up here, and enables a view both on the upper side 12 and on the lower side 14. At least one sensor element 20 may be arranged both on the upper side and on the lower side 12, 14 on the sensor assembly 100 according to the invention.

This arrangement may enable the sensor assembly to function in two directions (FIG. 2a). In principle, each of the outer surfaces of the sensor assembly can be equipped with sensor elements, such that a sensor assembly could function in all three spatial axes, respectively, in two directions. In FIG. 2b, such a sensor assembly having the sensor elements at least on two side surfaces 12, 13 is represented in a top view. The representation of sensor elements in the remaining side surfaces 11, 14 and in the front surfaces has been dispensed with. A sensor assembly as in FIG. 2b, together with further sensor assemblies being deviated by 90° respectively, could surveil (or monitor) a space (or chamber, or area, or volume) at its space borders. A sensor assembly according to FIG. 2c, in combination with further sensor assemblies, could surveil a space diagonally respectively, with an embodiment as in FIG. 2d also in the direct spatial axes.

At this time, the cross-section of a sensor assembly can assume plural possible shapes (FIG. 3). For an incorporation of respective sensor elements, those shapes (or forms) are suitable at best, which provide a plane surface with respect to the dimensions (or sizes) or the number of the incorporated sensor elements, for which [purpose] a cross-section having corners (or angles) is most suitable.

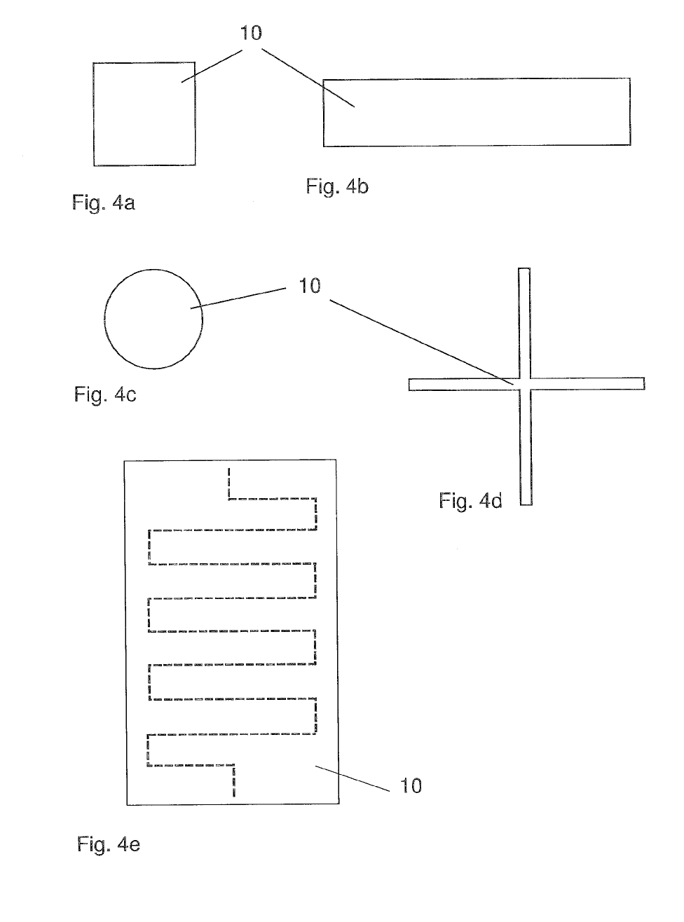

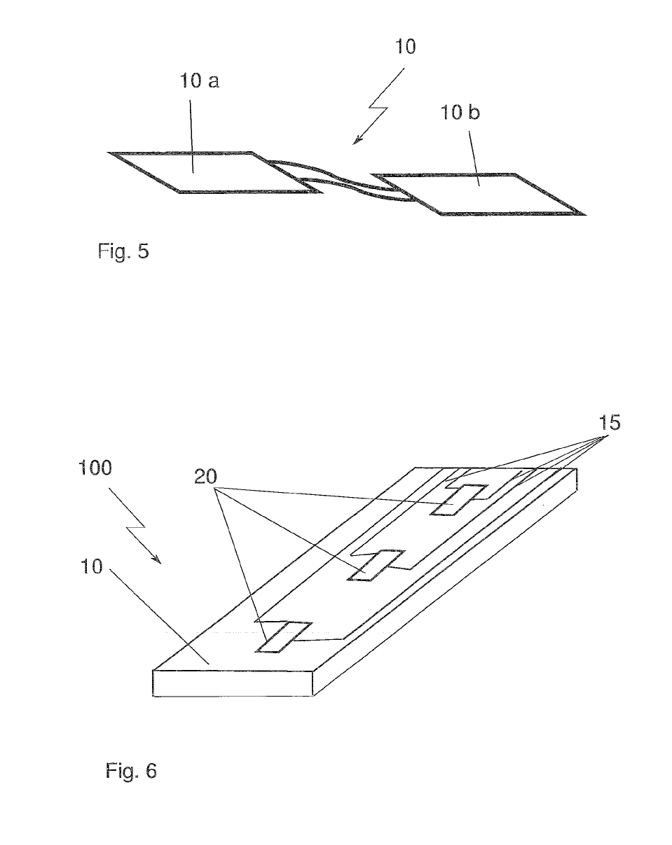

FIG. 4 show the top views of plural possible forms (or shapes) of sensor assemblies for a best possible adaptation to the space to be surveilled (or monitored) and its constructional shape (FIG. 4a-4c). If the sensor assembly is to be optimized with respect to the design shape of the space to be monitored, the assembly can be manufactured with a form (or shape), which is not holohedral (or not covering the whole surface), but nevertheless covering the space in a best possible way, such as cruciform (or crosswise) (FIG. 4d) or meander-shaped (FIG. 4e), wherein the sensors can be put on the dashed line, or the shape of the carrier is narrow and follows the dashed line.

In an embodiment according to the invention, the sensor assembly may be formed as a flat stripe (or strip) (FIG. 4b), i.e. the height may be much smaller than the width at this time, wherein the width may be smaller than the length. It is also possible to form a longer sensor assembly from a carrier 10 having two or also more sections 10a, 10b, which may incorporate the sensor elements later on, and to connect the sections to each other by one flexible partial section respectively, wherein the partial section may contain in particular also the electrical lines for the power supply and the signals of the sensor elements.

FIG. 6 shows a perspective view of a sensor assembly 100, in an embodiment according to the invention, having a stripe-shaped carrier 10. At this time, the carrier (or supporting device) 10 can be manufactured from a rigid or from a flexible material, but also from a composite of plural layers of a same material or of different materials. In the embodiment according to the invention, the carrier 10 may act at the same time as a conductor board, and may be provided with corresponding conductor paths 15 as well as points (or locations) for contacting the sensor elements 20 and/or possibly further electrical components or component groups. The conductor paths 15 as well as also the contact surfaces for the sensors can be applied directly on the carrier, or also on a foil (or sheet), which may be laminated on the carrier later on.

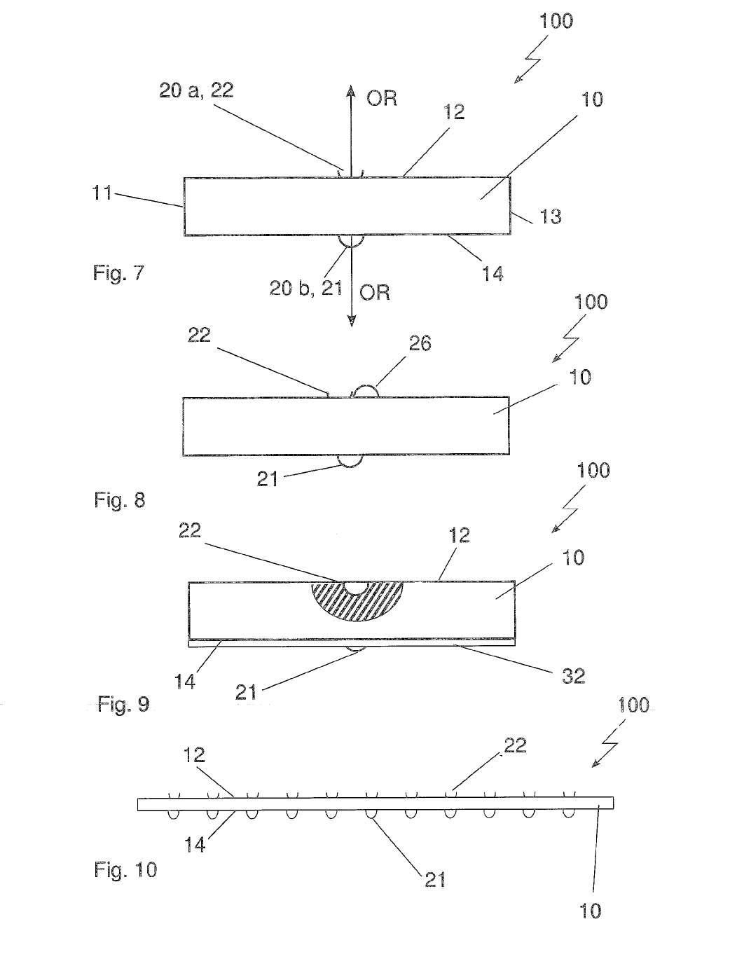

FIG. 7 shows the front view of a sensor assembly 100 according to the invention having one sensor element 20 arranged, respectively, on an outer surface 12, 14. The sensor elements 20 may be, respectively, exemplars of one type of device, and namely formed as a signal transducing device (or signal transducer) 21 or as a signal receiving device (or signal receiver) 22. The signal transducing devices and the signal receiving devices may be implemented for signals of one type. According to the principle of transmitter-receiver, these may be all types of signals, which may be transmittable and receivable (or capable to be transmitted and to be received), in particular light signals, preferably IR (infrared) light or acoustical signals, preferably ultrasound signals. Light signals are assumed in the further embodiment examples. Here, the signal transducing devices 21 are represented schematically as circles or closed semi-circles, while the signal receiving devices 22 are represented schematically as open semi-circles and/or “dishes” having the opening pointing away from the respective outer surface. For the sensor elements 20, an orientation direction OR is to be understood such that a straight line may lead from their center point and from the highest and/or deepest point of the circle line with respect to the respective outer surface, which straight line may indicate the major output or entry direction of the signals.

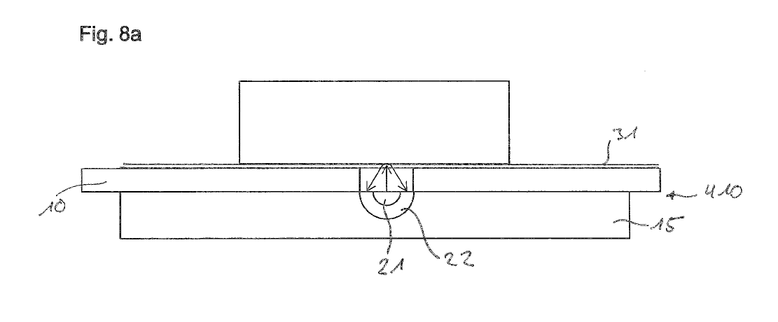

In a further embodiment according to the invention, a test signal transducing device (or test signal transducer) 26 may be arranged beside (or is associated to) a signal receiving device 22, i.e. in immediate or at least collateral distance to the signal receiving device 22 (FIG. 8). Thereby, the operational reliability (or functional safety) of the sensor assembly and/or of the superordinate system can be improved by thereby testing the functional efficiency of the signal receiving device again, if a signal of a first opposing sensor assembly has been transmitted, but no signal has been received. Basically, the same principle may also be applied to a signal transducing device.

In FIG. 8a, the signal transducer 21 and the signal receiver 22 of a sensor assembly 100 may be arranged pairwisely (in a pair) on the same conductor board, in particular directly adjacently. The signal transducer 21 and the signal receiver 22 may be assigned to an opening located in the shelf 410, such that a signal emitted by the signal transducer 21 can be sent through the opening and can be received through the opening by the signal receiver 22. In this way, a shorter signal path may be ensured, such that the reliability of the sensor assembly may be increased. In particular, the opening can be covered by a film, such that a contamination (or pollution) of the opening and thus of the signal transducer 21 and of the signal receiver 22 may be prevented.

The sensor elements may be integrated in the carrier 10 at least partially on a respective outer surface both as a signal transducing device 21 and as a signal receiving device 22, so as to possibly protect an according to sensor element on the one hand, or to possibly also obtain a smooth outer surface on the other hand. In FIG. 9, a signal receiving device 22 is shown, which may be integrated completely in the carrier 10 in a partial section on an outer surface 12. At the lower side 14, the integration of a signal transducing device may be effected by a further layer 32 laminated thereon such that the signal transducing device 21 may be considered to be integrated in the carrier at least partially, wherein the protection layer 32 may have recesses at the corresponding locations of the positions of a sensor element 20, and thus may also protect the sensor elements and/or the corresponding conductor paths or may provide a smooth outer surface (FIG. 9).

The signal transducer 21 could alternatively also be arranged on the upper side of the shelf (reference numeral 21′), in particular directly adjacently to the signal receiver 22. The signal emitted by the signal transducer can thereby be received simpler by the signal receiver, if the distance between the signal transducer and the signal receiver is shorter and/or if the signal does not have to traverse the receiving space of the compartment. In particular, the signal can be embodied weaker, such that the danger of an influencing by the signals of neighbouring signal transducers is lower. A further advantage may consist in that no mutual alignment between the signal receiver and the signal transducer needs to be effected in the compartment. The alignment may be effected already by the arrangement on the conductor board. This may have the advantage that during the manufacturing of the shelf unit, a greater manufacturing tolerance may be possible, because no alignment relative to each other of the shelves and/or of the sensor assemblies at the shelves may be required.

FIG. 10 shows a side view of a sensor assembly 100 having a plurality of sensor elements 21, 22 arranged at a respective outer surface 12, 14, wherein only sensor elements of one type (of device) may be arranged on one outer surface, respectively. In this manner, many sensor assemblies can be combined with each other cascadingly (or in a cascaded manner), i.e. oriented always in one direction. The distance of the sensor elements among each other on one respective outer surface can be selected such that a signal transducing device always may address (or appeal to) only one signal receiving device or also plural signal receiving devices by arranging the sensor elements 21, 22 so close to each other that the signal cones may overlap on the receiver side.

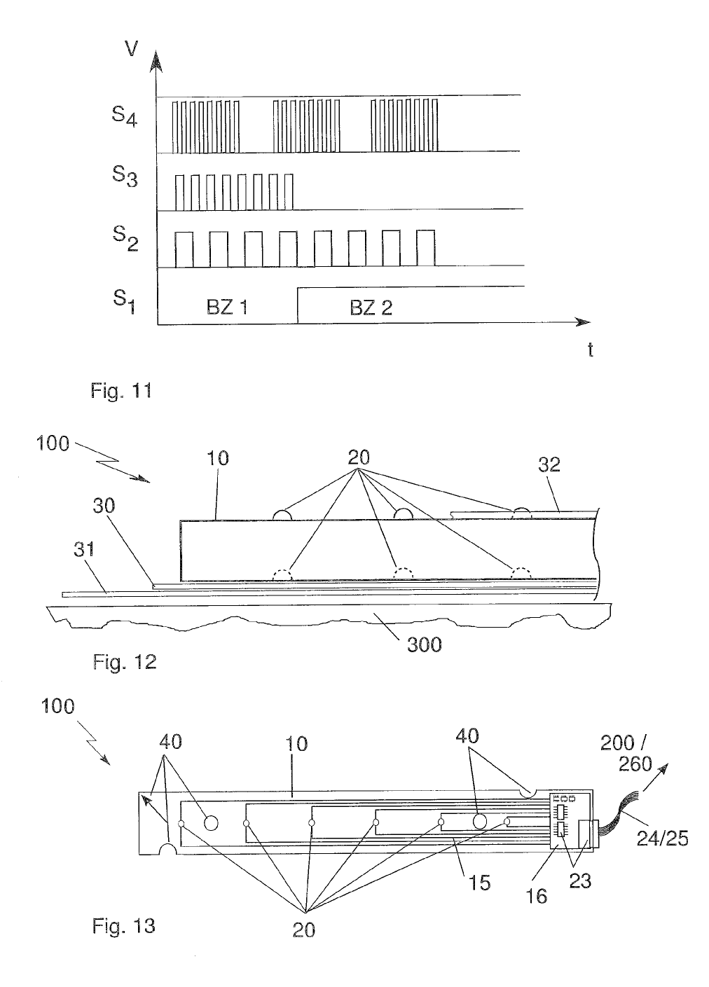

FIG. 11 shows a diagram with respect to plural signals. A first signal 51 shows two different occupancy states BZ1 and BZ2, wherein no signal 51 may be received in the occupancy state BZ1 and thus may be interpreted as a sensor area 21/22 that may be occupied with storage goods, whereas a signal 51 is received in the occupancy state BZ2 and thus may be interpreted as a sensor area without storage goods G. Signals 2-4 show signals having different intensity, modulation or having individual frequency blocks. These signals can be used for improving the signal and/or data integrity, or also for addressing or identifying individual sensor elements, in particular in the case of overlapping signal cones.

FIG. 12 shows a side view of a sensor assembly according to the invention having again a plurality of sensor elements 20 arranged on opposite outer surfaces of the carrier 10, wherein the upper sensor elements 20, by a protective layer 32, may be embedded at least partially in a protective layer 32, and thus an approximately smooth surface may be achieved. By contrast, on the opposite outer surface, the sensor elements 20 may be integrated completely in the carrier 10. On this lower side, an adhesive layer 30 may be applied, which may be covered by a non-adhesive covering layer 31. At least the adhesive layer 30 may have recesses at the positions of the sensor elements 20, so as to not damage or contaminate the sensor elements 20, and so as to let pass the signals unobstructedly (or unhinderedly) later on. For a later mounting, the non-adhesive covering layer 31 may be removed from the adhesive layer 30, and thus can be aligned on a device 300 and affixed (or mounted) to the device 300 by the adhesive layer 30.

FIG. 13 shows, in a top view, a sensor assembly 100 according to the invention having a carrier 10 and conductor paths 15 arranged on the carrier 10 as well as sensor elements 20 connected to the conductor paths 15. A small rigid conductor board may be mounted at the right end of the sensor assembly, which conductor board may contain the control electronics 16 that may be necessary for controlling the sensor elements 20 and further electric or electronic components 23, for example a plug connector element 23 [to be used] for power supply and for receiving and/or outputting control signals 24/25 of the sensor elements 20 for transmission to a superordinate sensor system 200 and/or to a superordinate control system 260. The sensor assembly 100 may have additional markings and/or devices 40 for fixing to a device, which may be implemented as optical (or visible) markings (e.g. as an arrow) or as shapes (e.g. semi-circles, drill holes). In particular, the drill holes can be used to fix the sensor assembly 100 to a defined position with a screw etc. later on.

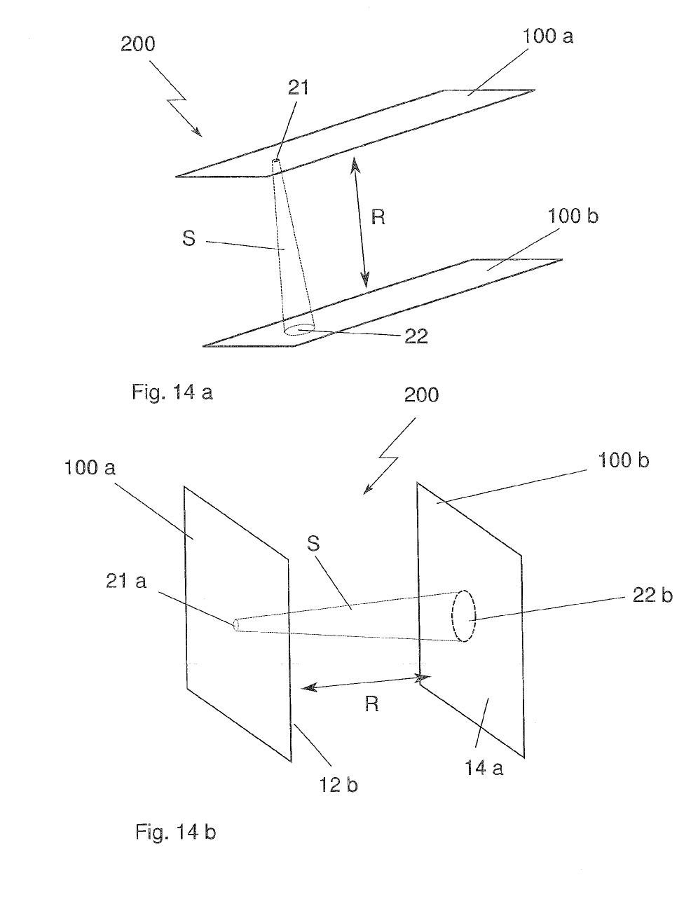

FIG. 14a shows schematically the arrangement of a sensor system 200 consisting of a surveillance space (or monitoring chamber, or monitoring area) R and two sensor assemblies 100a, 100b, which may border or encompass this space (or chamber) at least partially, wherein the sensor assemblies may oppose each other at least partially. The sensor assemblies 100a, 100b and/or the sensor elements 21, 22, which may be arranged on these mutually facing outer surfaces, may be arranged at this time such that at least one signal transducer 21 of the first sensor assembly 100a may approximately oppose a signal receiver 22 of a second sensor assembly 100b, such that a signal emitted from the signal transducer 21 can be sent through the surveillance space R to the signal receiver 22 of the second sensor assembly 100b and can be received. Such an arrangement can be implemented in space arbitrarily. FIG. 14b shows two vertically aligned sensor assemblies 100a, 100b, wherein here the signal S may be sent horizontally through a surveillance space R and received.

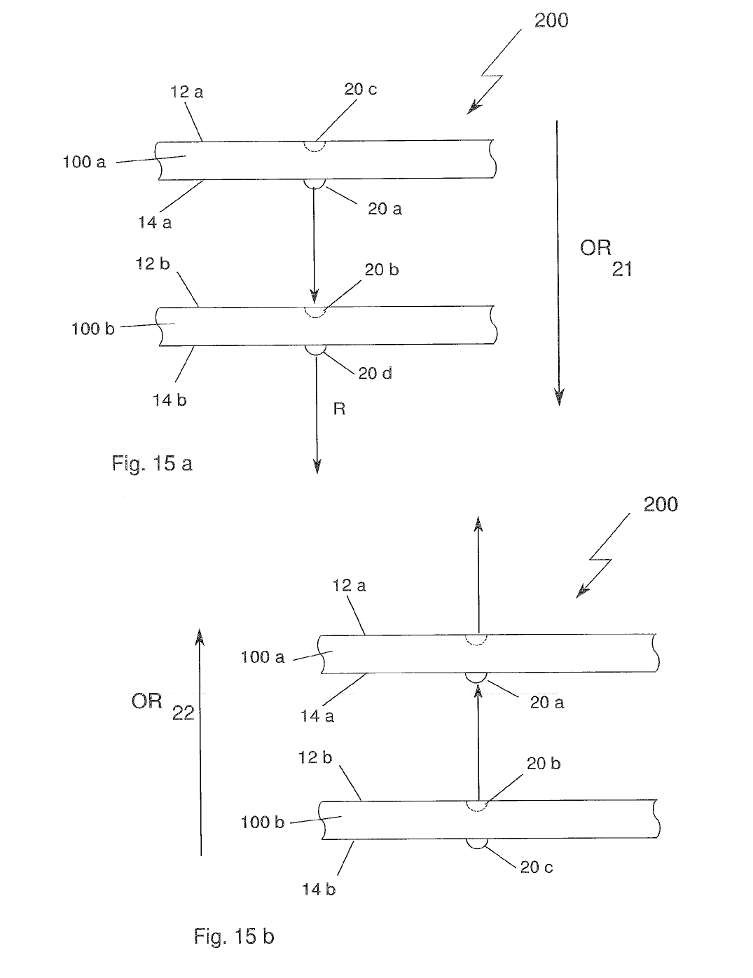

FIG. 15 a shows, in a side view, an embodiment according to the invention of a sensor system 200 having an arrangement of two sensor assemblies 100a, 100b, wherein the sensor assemblies may be aligned opposingly relative to each other such that the sensor elements 20a and 20b arranged at the mutually opposing outer surfaces 14a and 12b can interact with each other, i.e. a signal sent from a signal sensor element 20 can be received by a second sensor element 20b.

At this time, the sensor elements may be positioned and selected in terms of their type with respect to each other such that in the sensor assemblies 100a, 100b, at their outer surfaces 14a and 12b facing each other, always one signal transducer 21 and one signal receiver 22, respectively, may be opposing each other. Further sensor elements may be arranged on the outer surfaces of the two sensor assemblies 100a, 100b, which may face away from each other, wherein the further sensor elements may be respectively complementary to the very sensor element, which may be located on the respective sensor assembly on the outer surface facing the other sensor assembly. In this context, the term “complementary” refers to the respective other type of a sensor element. In FIG. 15a, the sensor assembly 100a with its outer surface 14a having a signal transducer 20 may be located facing the outer surface 12b of the sensor assembly 100b having a signal receiver 20b. Thus, the further sensor element 20c, which may be arranged on the outer surface 12a that does not face the sensor assembly 100b, may be embodied as a signal receiver. In the sensor assembly 100b, the further sensor element 20d may be formed as a signal transducer on the outer surface 14b that may face away from the sensor assembly 100a. Accordingly, all sensor elements of different sensor assemblies of respectively one type of the devices may each be oriented in one direction OR, and namely all signal transducers are oriented in a first direction OR 21 and all signal receivers may be oriented in a second direction OR 22 (FIG. 15b).

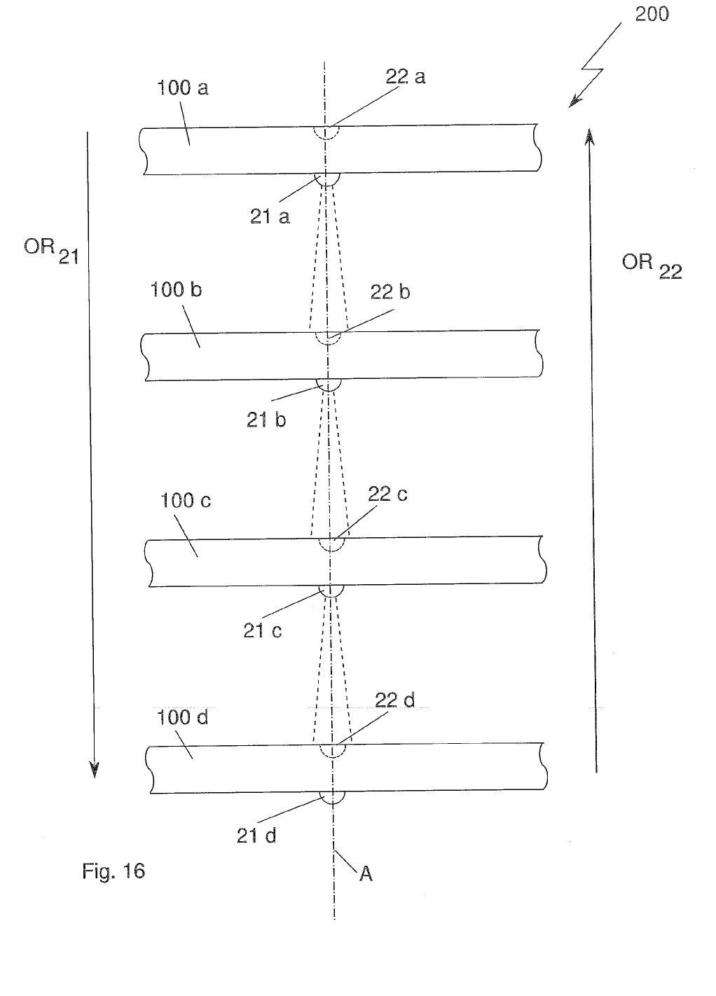

FIG. 16 shows, in a side view, a sensor system 200 according to the invention having four sensor assemblies 100a-100d, which may be arranged one over the other, in which the respective signal transducers 21a-21d may be oriented in a first direction OR 21 from the upper side downward, and all signal receivers 22a-22d may be oriented in a second direction OR 22 from the lower side upwards. In this manner, it may be possible to efficiently arrange plural sensor assemblies that may be identical in construction, in a total sensor system, and to combine them with each other cascadedly (or in a cascading manner). At this time, sensor elements, which may act with each other, of at least two neighbouring sensor assemblies may be arranged on a common axis A.

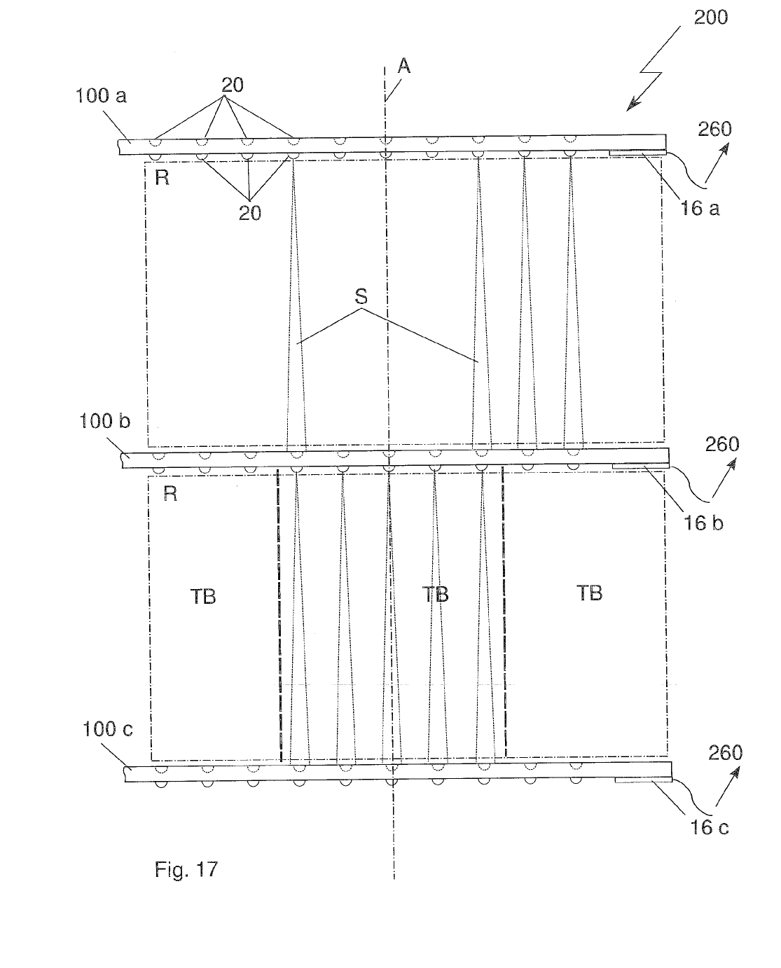

FIG. 17 shows a sensor system 200 according to the invention, having three sensor assemblies 100, which may be arranged over each other respectively, and which may have a plurality of sensor elements 20, respectively. The sensor elements of one type of the devices may be again oriented exclusively in a first direction OR 21 and in a second direction OR 22. The sensor elements, which may act with each other, of different sensor assemblies may all be located on a common axis A, respectively. Between two respective facing sensor assemblies 100, there may be a surveillance space R (or monitoring area), respectively, which may have a plurality of signal elements of different sensor assemblies, which elements may act together at least pairwisely (or in pairs). The surveillance spaces R can be subdivided in smaller partial sections TB, in that the control electronic 260 respectively may define groups and may assign these groups to the respective partial sections TB.

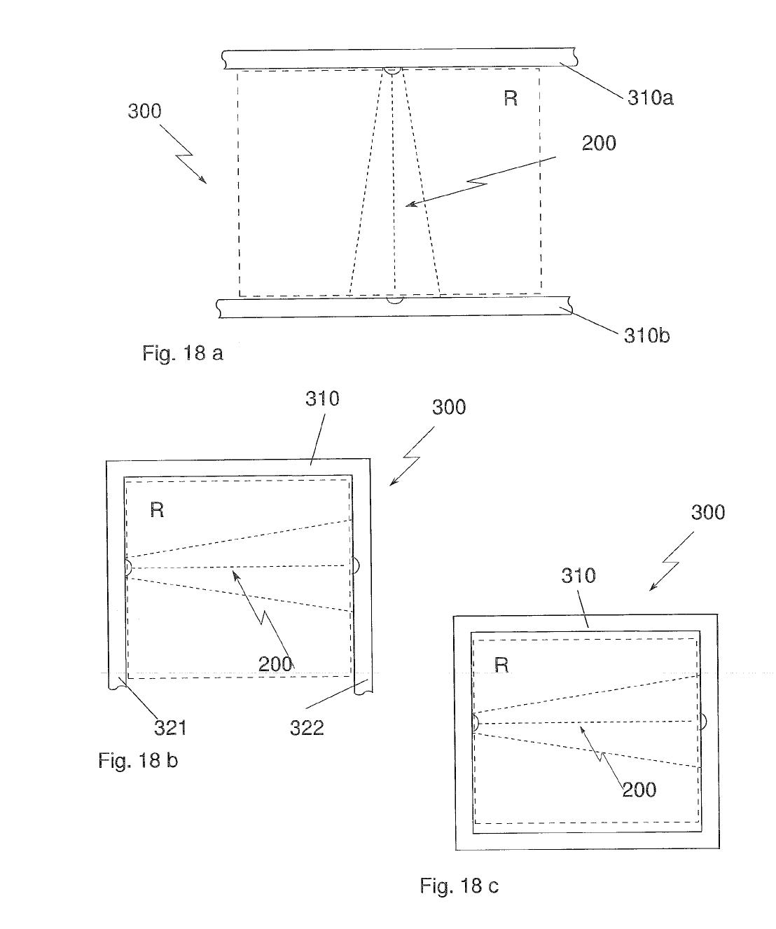

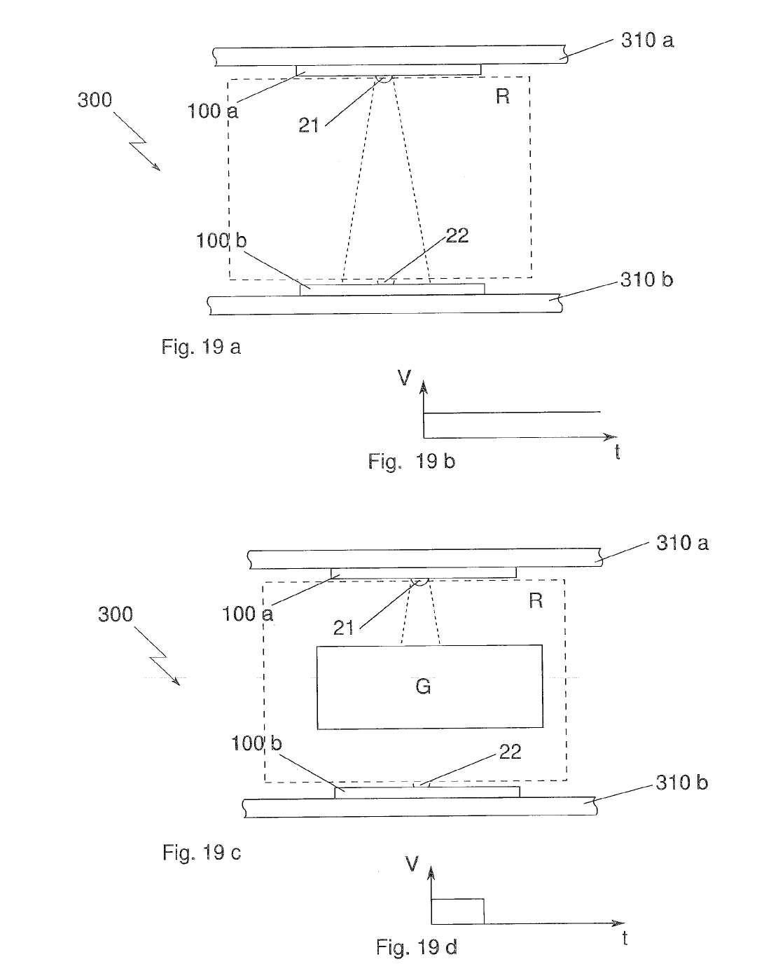

FIG. 18 show schematically a storage device 300 having a sensor system 200. To this end, the storing device 300 may have a storage space (or storage chamber) R for receiving and/or a deposit space (or positioning area), for a storage good, which space may be at least partially bordered and/or enclosed by a delimitation element 310 or by sections 321, 322 of a delimitation element 310 or by two different delimitation elements 310a, 310b. In an embodiment, for this purpose, a sensor system 200 having two different sensor assemblies 100a, 100b may be arranged on two delimitation elements 310a, 310b, such that at least one signal transducer 21 of the first sensor assembly 100a can interact with at least one signal receiver 22 of the second sensor assembly 100b, wherein a signal S sent by the signal transducer 21 may be sent through the surveillance space R to the signal receiver 22 (FIG. 19a). If no storage good blocks the path of the signal S, then the signal receiver 22 may receive the signal S sent by the signal transducer 21 and may interpret this as a first occupancy state BZ1, namely that no storage good may be contained in the surveillance space R (FIG. 19b).

However, if a storage good G is contained in the surveillance space R, the signal path S may be disturbed and a signal S sent by a signal transducer 21 cannot be received by the signal receiver 22, which may be interpreted as a second occupancy state BZ2, namely that a storage good may be present in the surveillance space R (FIG. 19d).

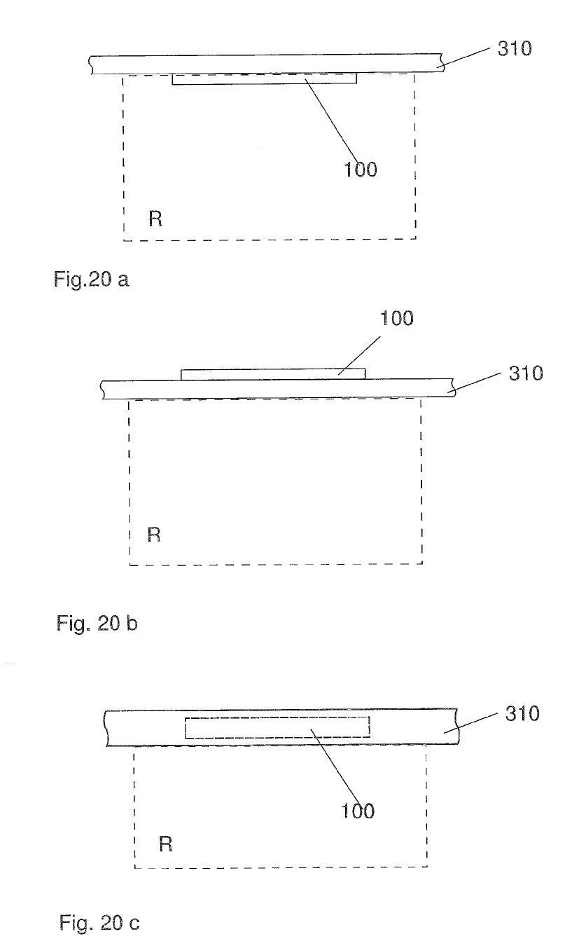

FIG. 20 show different possibilities according to the invention of the arrangement of a sensor assembly 100 on a delimitation element 310. A sensor assembly 100 may be arranged either on an outer surface of a delimitation element 310, which surface may face the surveillance space R (FIG. 20). A second possibility may be to arrange the sensor assembly 100 on an outer surface of a delimitation element 310, which surface may face away from the surveillance space R (FIG. 20b). A further possibility may be to integrate a sensor assembly 100 at least partially in a delimitation element 310 in a respective recess 318 (FIG. 20c).

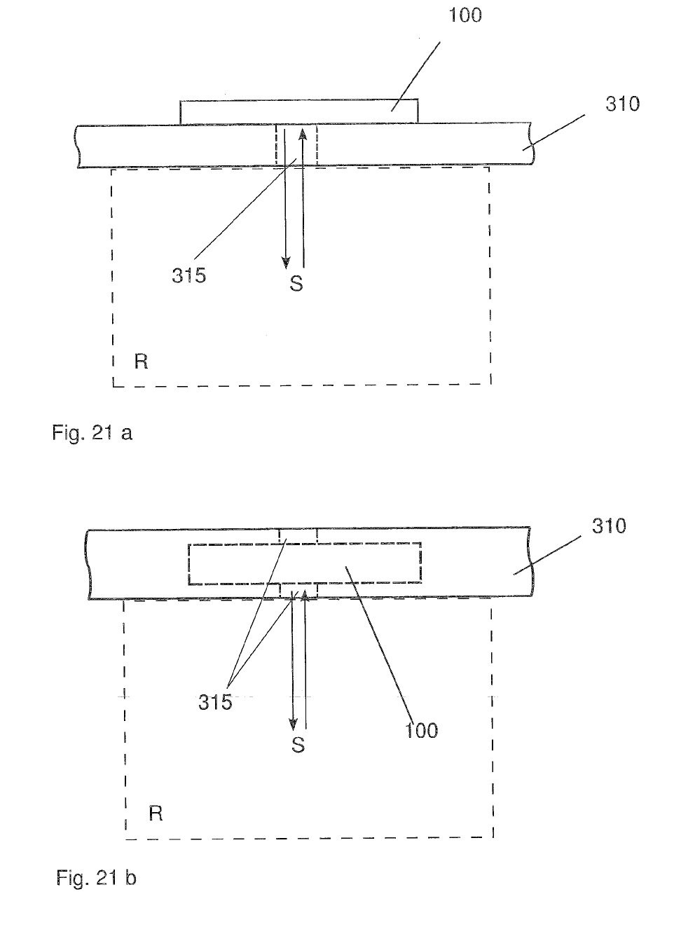

In an embodiment according to the invention for the arrangement of a sensor assembly 100 according to the FIGS. 20b and 20c, according to which the sensor assembly 100 and sensor elements 20 arranged therein would have no access to the surveillance space R and thus could send or receive no signals S, an opening may be introduced in the delimitation element 310 as a signal opening 315 for the passing through of signals of the sensor elements. This signal opening 315 can be either punched or drilled into the delimitation element 310, and may enable a sensor element 20 for an interaction with a complementary sensor element through the surveillance space R. FIG. 21a shows a sensor assembly, which may be arranged at a back side of a delimitation element 310 facing away from the surveillance space R, and which may have a signal opening 315 through the total strength (or thickness) of the delimitation element 310. In an integrated sensor assembly 100, there may be provided at least one signal opening 315 on at least one side or at least two signal openings 315 on both sides at the respective locations of the sensor elements 20 (FIG. 21b).

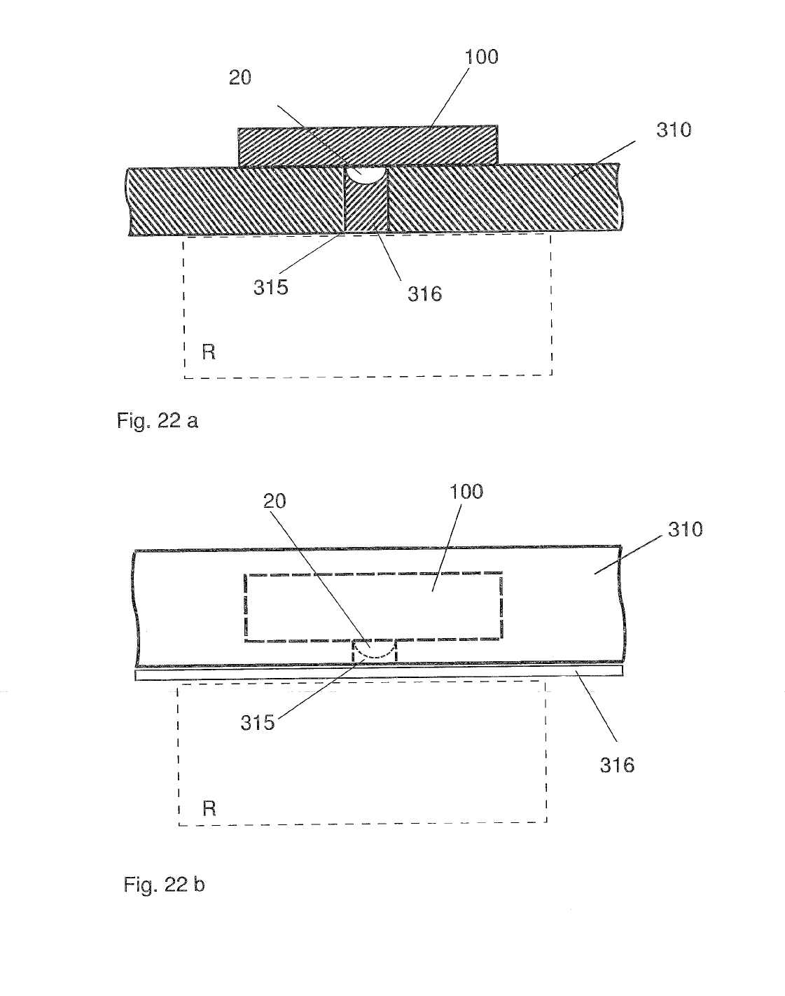

The sensor element 20 may protrude from the surface of the sensor assembly 100 and thus may fill such a signal opening 315 at least partially. At this time, the sensor assembly may be positioned and at least in an attempt fixed in relationship to the delimitation element, such that the at least one sensor element 20 may come securely in coverage with the signal opening 315. In a further embodiment, the signal opening 315 may be filled at least partially with a material 316, which may be transparent for the type of signal used by the sensor elements, e.g. with a transparent synthetic resin. Thus, a smooth surface may be present and no dirt, which would disturb the signals, can accumulate in the signal openings (FIG. 22a).

Alternatively or in addition, a further protective layer 316 may also be applied, e.g. a foil (or film) or an adhesive tape of a transparent material (FIG. 22b).

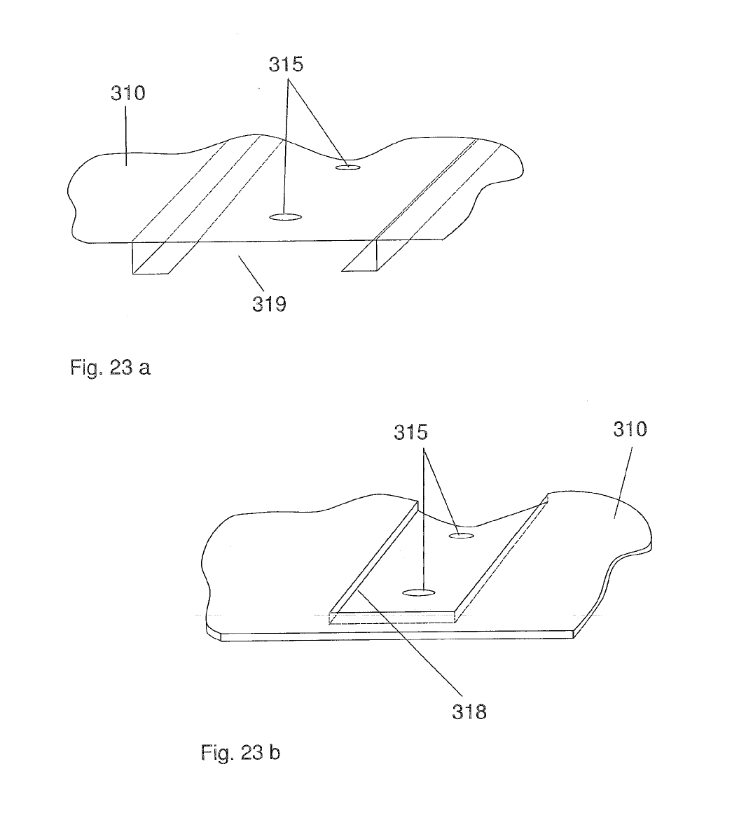

In one embodiment of the invention, for the arrangement of a sensor assembly 100, a device (FIG. 23a) or a receiving space 318 (FIG. 23b) may be arranged at a delimitation element 310. FIG. 23a shows a device having an opening 317, into which a sensor assembly (not represented) can be pushed, and which may engage behind the device, such that the sensor assembly may be held securely at an outer surface. In the delimitation element 310, signal openings 315 corresponding to the surveillance space R may be introduced, such that the sensor elements of a sensor assembly (not represented) can send or receive signals.

FIG. 23b shows a recess, which is intended for the receiving of a sensor assembly (not represented), the recess possibly being in the form of a cavity 318, which may be accessible from above. In a further embodiment, a sensor assembly 100 may be laid flushingly thereinto. Signal openings 315, which may open downwardly, may be introduced in the cavity.

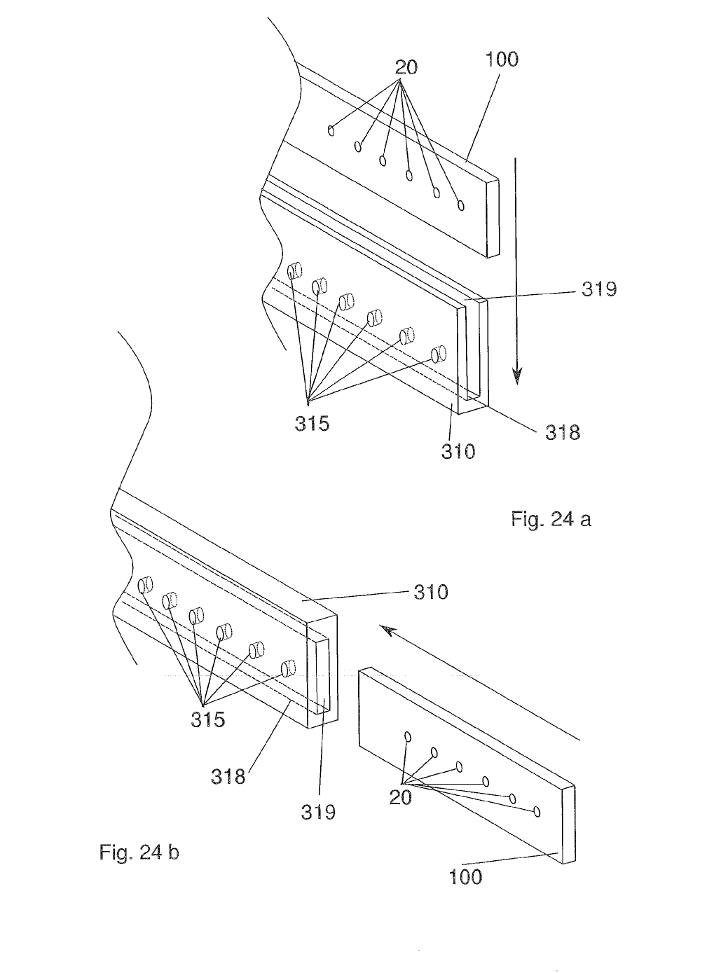

FIG. 24a shows a delimitation element 310 having a cavity 318, which may open upwardly, into which a sensor assembly 100 can be put into from above. FIG. 20b shows a delimitation element 310 having a cavity which may open towards a side, and into which a sensor assembly 100 may be insertable.

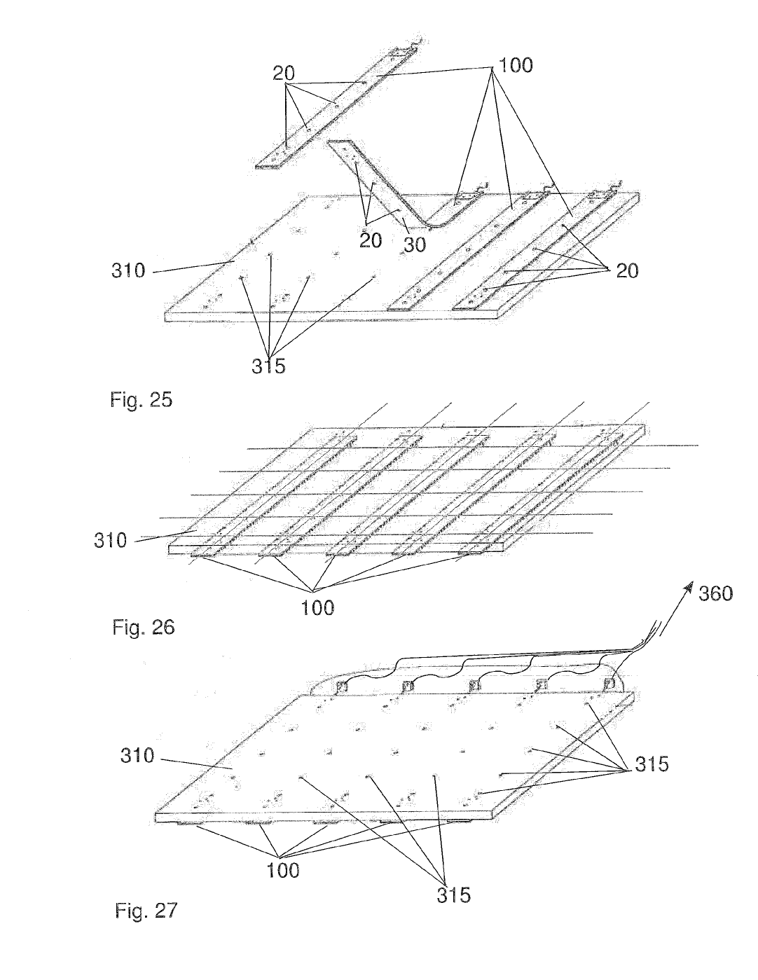

FIG. 25 shows the lower side 14 of a plate-shaped delimitation element 310 having a placement side for storage goods located at the upper side and accordingly with a surveillance space, which may be lying at the upper side with respect to the gravity F, and on which plural sensor assemblies 100 may be arranged parallel to each other. The sensor assemblies 100 may be aligned on the delimitation element 310 according to the sensor elements 20 arranged on the outer surfaces such that the sensor elements 20 may come in coverage with the corresponding signal openings 315. The flexible sensor assemblies 100 may be subsequently fixed to the outer surface 14 of the delimitation element 310 with an adhesive layer present on one side [of the sensor assembly].

Each sensor assembly 100 may have a plurality of sensor elements 20, which may be arranged, respectively, in a row (or line) at the respective sensor assembly 100. Because plural sensor assemblies 100 may be arranged on the delimitation element 310, respectively, parallel to each other, there may result a sensor matrix (FIG. 26), which can be controlled and/or evaluated selectively also in partial areas, respectively, with a control electronics 260 (FIG. 27).

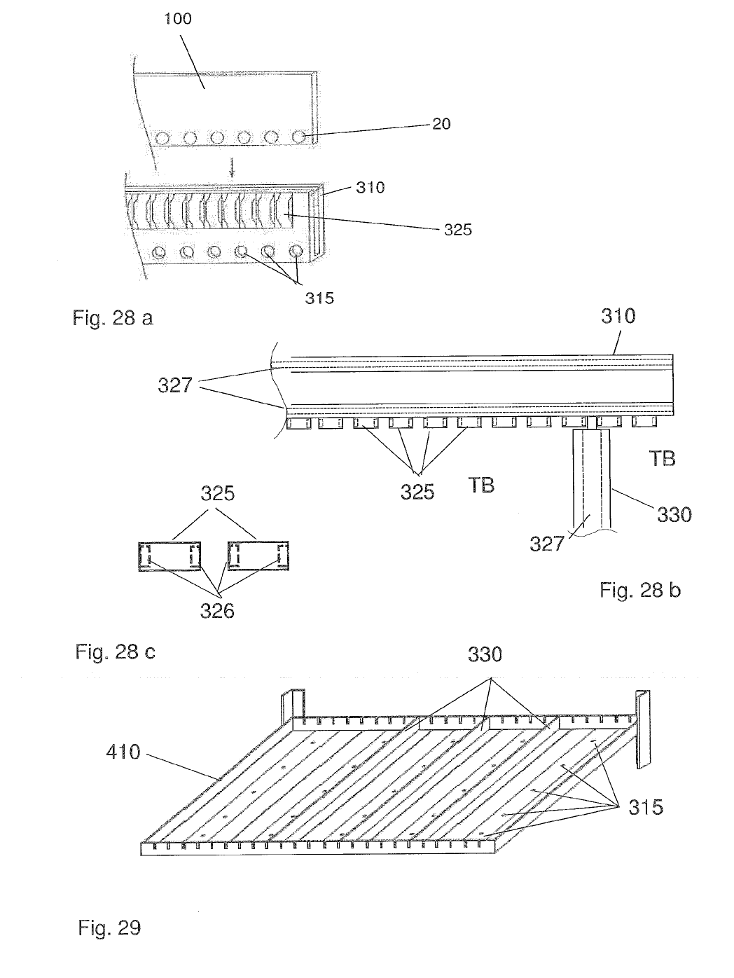

In an embodiment according to the invention, the delimitation elements 310, which may border or enclose a surveillance space, may have devices 325 (FIG. 28a) for receiving further delimitation elements 310 and/or separating elements 330 for the establishment of partial sections (or sub-sections) TB within a surveillance space R (FIG. 28b). For this purpose, the further delimitation elements 310 or separating elements 330 may be inserted (or slid-in) the devices 325 from above, such that an approximately rectangular corner, and in connection with the same procedure at the other end of the inserted delimitation element 310 or separating element 330, in total an isolated (or partitioned) partial section TB may be generated. In one embodiment, the devices 325 may have contact surfaces 326 at their sides (FIG. 28c), such that delimitation elements slid in there and the sensor assemblies contained therein may be connected electrically with the sensor system and/or the storage device. Furthermore, the delimitation elements 310 or the separating elements 330 may contain current lines and data lines 327, so as to possibly integrate inserted elements in the power supply and data lines of the drawer 523.

FIG. 29 shows in perspective a shelf 410 having sensor assemblies arranged at the lower side 14 and signal openings 315 passed through the supporting surface for storage goods. In addition, the shelf may be subdivided in plural shelf compartments by separating elements 330 extending parallel to the sensor assemblies. A frame, which may run around the shelf on all sides may prevent a lateral falling out of stored storage goods G.

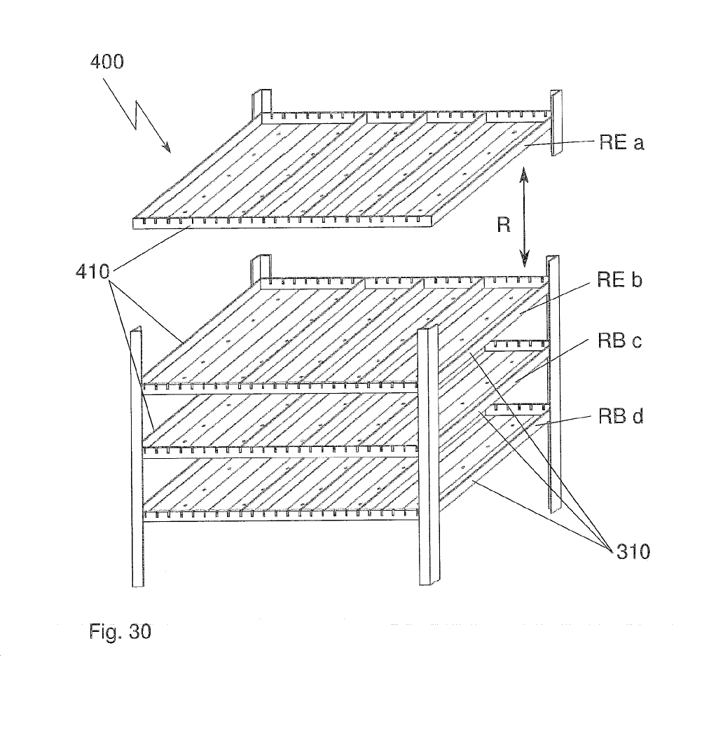

FIG. 30 shows a storage device 300 formed as a shelf unit (or rack) 400 having a first shelf 410 for receiving storage goods as well as further shelves 410, wherein, due to the spatial arrangement relative to each other, a surveillance space R may be defined, respectively, between two shelves 410, wherein a plurality of sensor assemblies 100 may be arranged at the lower side of the shelf 410 located above the surveillance space R.

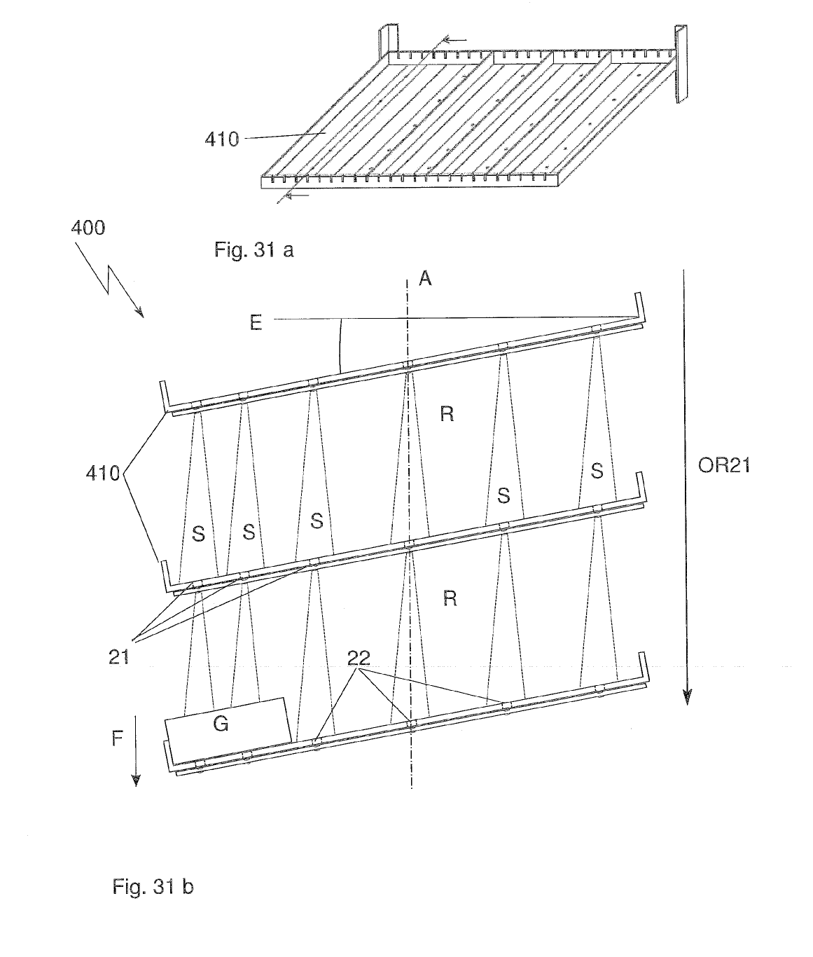

FIG. 31 shows a section through a shelf unit 400 having in total three shelves 410 and two surveillance spaces R. The section may cut through a sensor assembly 100 arranged at the position (or height) of sensor elements 20 arranged on a line. At the lower side of each shelf 410, a sensor assembly 100 may be arranged, wherein the signal transducers 21 may be oriented from the top downwardly and the signal receivers 22 may be arranged from the bottom upwardly. At one side, the shelves have a slope (or decline), which may make sure that the gap of (or left by) a withdrawn storage good G, e.g. a package with screws, may be closed by sliding-down packages, and that a package may always be available at the front at a withdrawal location as long as there are still packages in the corresponding goods shelf. Packages that may be present in the storage shelf may prevent the receiving of signals S that may be sent from the signal transducers 21 arranged above the packages by the signal receivers 22 and may be obscured by the packages, so that a signal S, which may be sent but not received, may be interpreted as a first occupancy state and as “being present”. At locations, where no package may be present any more, a signal S can be received, which may be interpreted as a second occupancy state and as “empty”. The individual occupancy states may be prompted either periodically or due to an event, e.g. a manual request, and may be signalled to a superordinate management system, which may perform an inventory update on the basis of the storage location and/or the assignment of a surveillance space R and/or its partial sections TB to particular goods, and may trigger order transactions as the case may be.

If the length of the individual articles and/or the number of articles per unit length is known, for example also the number of the articles in the respective subarea TB can be determined. For example, the length of the individual articles can be known already, or this may be determined during the setting up of the shelf unit 400 and may be stored. For example, the position of the last sensor element having the occupancy state “present” and/or the position of the first sensor element having the occupancy state “empty” can be detected. Subsequently, the number of the articles can be input manually. With this information, as a function of the distance of the individual sensor elements, a calculation of the size of the individual articles and thus a precise determination of the number of the articles in the subarea upon withdrawal of individual articles may be possible.

Alternatively, the position of the last sensor element having the occupancy state “present” and/or the position of the first sensor element having the occupancy state “empty” can be stored. In order to check whether a minimum amount of the respective article is present, it can be sufficient to inquire only the sensor element assigned to this position. The time effort for an inquiry can thus be reduced significantly. For example, the shelf unit system can be filled with the minimum amount during the setting up of the shelf unit system, and the position of the last sensor, which may indicate an occupancy, and/or the position of the first sensor element, which may indicate no occupancy, can be detected.

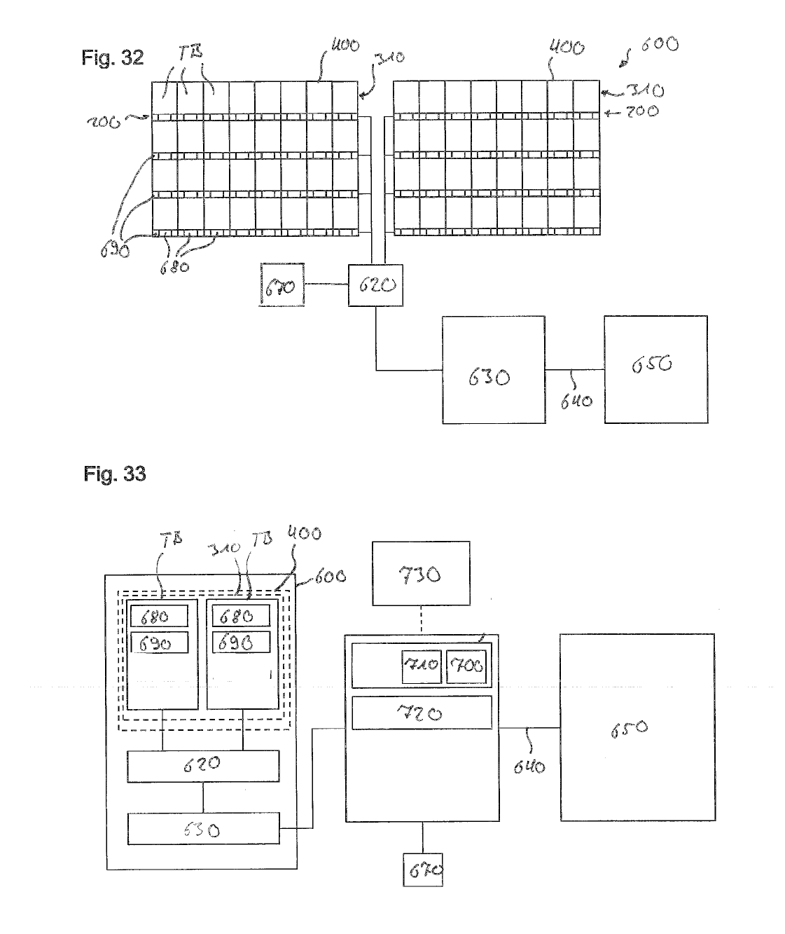

FIGS. 32 and 33 show a storage system 600 having plural shelf units 400, which are represented for example in FIG. 31. Each shelf unit 400 may have shelves 310, which may be respectively subdivided in subareas and/or compartments TB. The shelf units 400 can concern for example shelf units having inclined shelves, in which the shelves 310 may be inclined in a filling direction and/or a withdrawal direction, as is described in the FIGS. 31a and 31b. The compartments TB may run in the withdrawal direction, such that the articles arranged on the shelves 310 may slide respectively to the frontal, deeper end of the shelves 310.

The storage system 600 may further have a sensor system 200, which may consist of sensor assemblies 100, wherein one sensor assembly 100 may be assigned to each compartment TB. The sensor assemblies 100 may each be configured to scan the occupancy of the compartments TB, and to generate an occupancy information. A unique address, which may be figured (presented) on a barcode 680 on the front side of the compartment, may be assigned to each of the compartments TB.

Furthermore, a data bus 620 may be provided, which may be connected to a communication device 630, which can establish a network connection 640 with a server 650. The communication device 630 can send the occupancy information received via the data bus as well as the address of the compartments TB associated with the occupancy information via the network connection 640 to the server 650. Furthermore, the communication device 630 can receive control information of the server 650 via the network connection 640. For example, the control information may be instructions for performing a stock-taking or information for performing a remote maintenance.

The storage system may further have a hand-held scanner 670 for optically detecting (or measuring) an optically readable code, wherein each of the compartments TB may carry an optically readable code indicating the respective address. The communication device may be configured such that the assignment of a goods type to one or more of the compartments TB may be effected in that the communication device 630 may receive from the hand-held scanner 670 an optically measured address and a goods type assigned to the optically measured address.

The hand-held scanner can be configured wirelessly and can have a wireless communication interface for communicating with the communication device.

The compartments may further have signalling means 690, which, for example after receipt of a false occupancy signal, may output an optical signal that may indicate optically a false occupancy for a user.

For setting up the storage system 600, the communication device 630 may firstly be switched in a setup mode. Subsequently, there may be effected an occupation of the compartments TB of the storage system 600 according to a predetermined occupancy plan 700 with minimum stock amounts, below which repeat orders shall be prompted, as well as a detection of the minimum stock quantities by the sensor system 200, and a storage of the minimum stock quantities in the communication device. Finally, there may be effected a completion of the occupancy to the nominal stock in the storage system 100.

The operation of the storage system 600 after the setup may be effected by the following steps:
detecting the occupancy information 710 of at least one of the compartments TB,
comparing the detected occupancy information 710 with a stored occupancy plan by the communication device 630,
if a discrepancy between the detected occupancy information and the occupancy plan is detected by the communication device 630, generating a false occupancy signal by the communication device 630 and sending the false occupancy signal via the data bus to the address of the respective sensor assembly 100, from which the occupancy information has been measured.

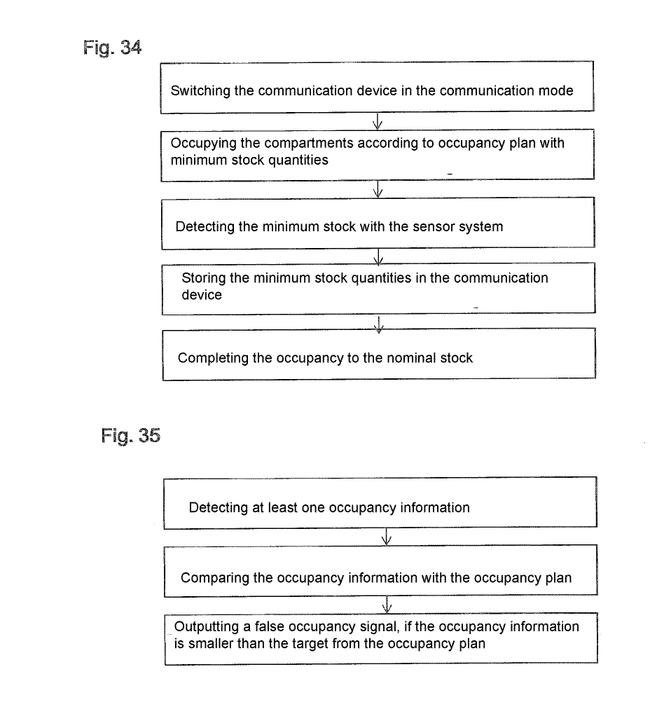

The process of the setting up as well as of the operation of the storage system 600 is indicated schematically once more in the FIGS. 33 and 34.

The storage system 100 can perform the occupancy detection permanently or periodically, for example in order to record respectively a present stock of products (or goods in stock) by storing the occupancy information in the communication device 630. Alternatively, the occupancy determination can be effected only at fixed points in time or in response to a request. For example, a stock-taking point in time may be fixed, at which the storage system may perform an automatic stock-taking (or inventory), i.e. an occupancy detection of all compartments TB.

A remote maintenance program module 720 may be stored on the communication device 630, which module may be addressable via the network, and which can perform maintenance processes directly on the storage system. The remote maintenance program module may be configured for example such that upon (or in response to) the receipt of a command over the network the sensor system 200 may be activated such that the occupancy information of a compartment TB specified in the command by the statement of a corresponding address may be detected, and based on the occupancy information an occupancy information signal may be generated, which may be sent via the network.

The communication device 630 may be configured to be connected to a computer 730 via a local connection so as to visualize an occupancy plan 700 stored in the communication device 630 on a user interface of the computer.

The communication device 630 may further have a setup mode, wherein an occupancy of the storage system 600, which occupancy may have been measured by the sensor system 200 in the setup mode, can be stored as an occupancy plan, wherein the occupancy plan may comprise in particular the goods type assigned to each compartment TB and an occupancy threshold value assigned to this goods type, which threshold value may be given by the occupancy measured by the sensor system 200.

The shelves 310 may have openings in the filling direction of the compartments TB, in particular in the direction of the slope so as to possibly enable a signal receipt and/or a signal emission by the sensor system 200, wherein the sensor assemblies 100 of the sensor system 200 may be located below the shelves 310, and may be covered by a film, which may have been applied on an upper side of the shelf 310 in the filling direction, and which may cover the openings.

The film may concern for example a plastic film, in particular a PVC film, wherein the plastic film may be transparent in particular in the range of a frequency of the signal receipt and/or the signal emission.

In the following, further features of possible embodiments are described, whereby the features are combinable among each other and with the features indicated above.

The sensor assembly (100) for an occupancy detection may have a carrier element (10) having at least two sensor elements (20), wherein the sensor elements (20) may be arranged on different outer surfaces (11), (12), (13), (14) of the carrier element (10).

The carrier element (10) may have for example an angled, preferably a triangular or a quadrangular, in particular a quadratic or rectangular, cross-section.

The carrier element (10) may be formed for example angledly, circularly, cross-shapedly, y-shapedly, strip-shapedly, grid-shapedly, meander-shapedly and/or star-shapedly.

The carrier element (10) may be for example rigid, flexible or semi-flexible, or may have at least two rigid, flexible or semi-flexible sections (10)(a) (10)(b), which may be connected to each other.

The carrier element (10) may be constructed for example from a film (or foil), or from plural layers of same or different films and/or materials.

The carrier element (10) may be formed for example at least partially as a printed circuit board having conductor paths (15), or may have at least electrical conductor structures for an electrical contacting and/or transmission of the signals of the sensor elements (20) and/or further electrical and/or electronical components (23) and/or for a connection to a data bus (24) and/or to a power supply (25) and/or for a connection to at least one further sensor assembly (100).

A sensor element (20) may be formed for example respectively as a signal transducing device (or signal transducer) (21) or as a signal receiving device (or a signal receiver) (22).

For example, a test signal transducer (26) may be associated to (or provided adjacent to) a signal receiver (22) such that the signal receiver (22) can detect directly or indirectly signals of the associated test signal transducer (26).

The at least first sensor element (20)(a) of a first outer surface (11), (12) of the sensor assembly (100) may be formed for example complementary to the at least second sensor element (20)(b) of a second outer surface (13), (14) of the sensor assembly (100), in particular that the first sensor element (20)(a) may be formed as a signal transducer (21) and the second sensor element (20)(b) may be formed as a signal receiver (22), or that the first sensor element (20)(a) may be formed as a signal receiver (22) and the second sensor element (20)(b) may be formed as a signal transducer (21).

The at least two sensor elements (20)(a), (20)(b) may be formed complementary with respect to each other and are arranged at respectively mutually opposing outer surfaces (11), (13) or (12), (14) of the carrier element (10), in particular that a first sensor element (20)(a) may be formed on a first outer surface (11), (12) as a signal transducer (21) and the second sensor element (20)(b) may be formed on a second outer surface (13), (14) opposite to the first outer surface as a signal receiver (22), or that a first sensor element (20)(a) may be formed on a first outer surface (11), (12) as a signal receiver (22) and the second sensor element (20)(b) may be formed on a second outer surface (13), (14), opposite to the first outer surface, as a signal transducer (21).

The sensor elements (20) may be arranged for example at least partially integrated on or in an outer surface (11), (12), (13), (14) of the carrier element (10).

The signal, which may be emitted by at least one signal transducer (21) and received by at least one signal receiver (22), may be for example a magnetic signal, an electromagnetic signal, or an acoustic signal.

The signal transducer (21) may have for example at least an LED, an OLED or a piezo-crystal, or may be formed of an array of [one of] these elements.

For example, IR light may be emitted from at least one signal transducer (21).

At least one sensor element (20) and/or at least one conductor path (15) may for example be printed.

For example, a control electronics (16) may be mounted on the carrier (10), wherein the control electronics may identify distinctly (or uniquely) the sensor assembly as opposed to other sensor assemblies.

The control electronics (16) may activate for example the sensor elements (20), and may register, may further process, and may transmit the data signals of the sensor elements (20).

The signal, which may be generated by the control electronics (16) and may be emitted by the signal transducer (21), may be variable for example in terms of its frequency and/or its intensity.

The emitted signal (S) may be for example clocked (or synchronized) such that the signal (S) may be coded.

For the present sensor elements (20), an operation state can be activated or inquired (or prompted) by the control electronics (16) for example individually, group-wisely or all at once, in particular, that a signal transducer may output a signal, or that a signal receiver may be queried as to whether it receives a signal.

The carrier element (10) may have more than two, preferably a plurality of, sensor elements (20) for example on at least one outer surface, which [sensor elements] may be arranged in a defined manner with respect to each other, preferably on at least one line or in at least one row.

Sensor elements (20) for different types of signals may be grouped jointly, and/or may be arranged alternatingly, on an outer surface (11), (12), (13), (14) of the carrier element (10).

For example, only sensor elements of one type of the devices may be, respectively, arranged on one outer surface (11), (12), (13), (14), in particular the sensor elements (20) arranged for example on an outer surface (11), (12), (13), (14) may be formed respectively only as signal transducers (21) or respectively only as signal receivers (22).

The signal transducers (21) and the signal receivers (22) may be for example grouped jointly, and/or may be arranged alternatingly, on an outer surface (11), (12), (13), (14) of the carrier element (10).

For example, a marking (40) may be present for a later positioning and/or alignment of the sensor assembly (100).

For example, a fixing device (40) may be present for a later positioning and/or fixing of the sensor assembly (100).

The carrier element (10) may have for example an adhesion surface (30) on at least one outer surface (11), (12), (13), (14).

The adhesion surface (30) may be for example covered at least temporally with a detachable covering film (or foil) (31).

A sensor system (200) for an occupancy detection may have for example at least two sensor assemblies (100)(a), (100)(b), wherein the sensor assemblies (100)(a), (100)(b) may be arranged in at least one position such that they may comprise at least partially a surveillance space (R), and such that an emitted signal (S) of at least one signal transducer (21) of a first sensor assembly (100)(a) may be detectable in at least one occupancy state (BZ) by at least one signal receiver (22) of a second sensor assembly (100)(b), so that a received signal (S) may be interpreted as a first occupancy state (BZ), and a sent, but not received, signal (S) may be interpreted as a second occupancy state (BZ).

For example, the sensor assemblies (100)(a), (100)(b) may be arranged in at least one position relative to each other such that at least a respective one of their outer surfaces (14)(a), (12)(b) may face another one at least partially, and that at least one sensor element (20)(a), (20)(b) may be arranged on each one of the at least partially facing outer surfaces (14)(a), (12)(b), which sensor elements may be, respectively, complementary to each other, in particular that the at least first sensor element (20)(a) may be formed as a signal transducer (21)(a) and that the at least second sensor element (20)(b) may be formed as a signal receiver (22)(b), or that the at least first sensor element (20)(a) may be formed as a signal receiver (22)(a) and that the at least second sensor element (20)(b) may be formed as a signal transducer (21)(b).

For at least one of the sensor assemblies (100)(b), for example at least one further sensor element (20)(c) may be arranged on at least one of the outer surface (11)(b), (13)(b), (14)(b), that does not face another sensor assembly (100)(a).

For at least one of the sensor assemblies (100)(b), for example at least one further sensor element (20)(c) is arranged on the outer surface (14)(b) that faces away from the other sensor assembly (100)(a).

The at least one further sensor element (20)(c) may be for example complementary to the type of the at least one sensor element (20)(b) on the outer surface (12)(b) that may face the at least one other sensor assembly (100)(a), in particular that the sensor element (20)(b) may be formed as a signal transducer and the sensor element (20)(c) may be formed as a signal receiver, or that the sensor element (20)(b) may be formed as a signal receiver and the sensor element (20)(c) may be formed as a signal transducer.

In relation to the arrangement of the at least two sensor assemblies (100)(a), (100)(b), for example the sensor elements (20) of respectively one type (21), (22) of the devices all may have the same orientation (OR), in particular that all signal transducers (21) may be oriented in a first direction (OR)(21) and all signal receivers (22) may be oriented in a second direction (OR)(22).

The first direction (OR)(21) and the second direction (OR)(22) may be for example oriented opposite to each other.

For example two, preferably a plurality of, sensor elements (20) may be arranged on an outer surface (11), (12), (13), (14) of a sensor assembly (100) or of a section (10)(a), (10)(b) of a sensor assembly (100) having a sensor element (20).

The sensor elements (20) of two neighbouring sensor assemblies (100) may be for example, respectively, positioned approximately on a common axis (A).

For example, only sensor elements (20) of one type may be arranged on the mutually facing outer surfaces (14)(a), (12)(b) of a sensor assembly (100) or of a section of a sensor assembly (10)(a), (10)(b) having sensor elements (20), in particular the sensor elements (20) arranged on a respective outer surface (14)(a), (12)(b) may be formed only as signal transducers (21) or only as signal receivers (22).

For example, the sensor elements (20) may be spaced at a distance to each other such that at least one pair of sensor elements (20) may be present for a smallest unit to be measured, in particular at least one signal transducer (21) and at least one signal receiver (22) may be present, respectively, for a smallest unit to be measured, preferably plural signal transducers (21) and plural signal receivers (22) may be present for a smallest unit to be measured.

For example, a control electronics (260) may coordinate pairwisely or groupwisely (or in a pairwise manner or in a group-wise manner) sensor elements (20), which may respectively function complementary and may act with each other, of the at least two sensor assemblies (100)(a), (100)(b) or of different sensor assemblies, in particular may synchronize [them] with each other, and in particular may control the transmission and the detection of signals S.

The surveillance space (R) may be subdivided into at least two partial sections (or sub-sections) (TB), wherein the partial sections (TB) may be, respectively, managed logically by the control electronics (260), wherein in particular at least one signal transducer (21)(a) and one signal receiver (22)(a) or a group of sensor elements (20)(a)(b), which may function complementary and may act with each other, may be assigned to a first partial section (TB)(1), and at least one further signal transducer (21)(b) and one further signal receiver (22)(b) or a group of further sensor elements, which may function complementary and may act with each other, may be assigned to a further partial section (TB)(2).

The control electronics (260) may evaluate for example the detected signals further, and may relay the signals and/or the determined occupancy states BZ to a superordinate storing device (300) or to a superordinate control unit (360) on the basis of a communication device (270).

A storing device (300) for storing and managing storing good (G), in particular piece good and/or bulk good, may have at least one surveillance space (R) for the receiving of the storage good (G), and a sensor system (200) described above.

The occupancy state (BZ) and/or the degree of filling (FG) of the surveillance space (R) may be for example monitored (or surveilled) by at least two approximately opposing sensor elements (20)(a), (20)(b), wherein in at least one occupancy state (BZ) an emitted signal (S) of at least one signal transducer (21)(a) of a first sensor assembly (100)(a) may be detectable by at least one signal receiver (22)(b) of a second sensor assembly (100)(b), such that a received signal (S) can be interpreted as a first occupancy state (BZ), and a sent, but not received, signal or a dampedly received signal (S) can be interpreted as a second occupancy state (BZ), wherein the combination of plural occupancy states can be interpreted as a degree of filling (FG).

The surveillance space (R) of at least two delimitation elements (310)(a), (310)(b) or of at least two sections (321), (322) of a delimitation element (310) may be for example at least partially defined (or delimited), wherein the delimitation elements (310)(a), (310)(b) or the sections (321), (322) may approximately oppose each other at least partially, respectively, with at least one outer surface.

For example, at least one sensor assembly (100) may be arranged, respectively, on a delimitation element (310)(a), (310)(b), or, respectively, on a section (321), (322).

At least one sensor assembly (100)(b) may be arranged for example on an outer surface (311)(b) of a delimitation element (310)(b), which outer surface may face away from the surveillance space (R).

On at least one side of the surveillance space (R), for example at least one sensor assembly (100)(b) may be integrated at least partially in the respective delimitation element (310)(b).

The delimitation element (310) may have for example at least one signal opening (315), so that the at least one integrated sensor assembly (100)(b) or the at least one sensor assembly (100)(b), which may be arranged on the outer surface facing away from the surveillance space (R), can send a signal (S) to at least one further sensor assembly (100)(c) through the signal opening (315) and/or can receive a signal (S) from at least one further sensor assembly (100)(a) through the signal opening (315).

The signal opening (315) may be filled up for example at least partially with a sensor element (20) and/or the signal opening (315) may be at least partially covered and/or filled up with a material that may be penetrable for the signal.

At least one delimitation element (310) may have for example a device or a recess (316) for an at least partial incorporation of at least one sensor assembly (100).

The device or the recess (316) on at least one outer surface may have for example an opening (317) for inserting a delimitation element (310).

At least one sensor assembly may be fixed for example to at least one delimitation element in a defined position with respect to a reference point (B) of the storage device (300) and/or of the delimitation element (310) and/or of at least one further sensor assembly (100).

At least one sensor assembly (100) may be glued (or fixed) to at least one delimitation element (310).

At least two, preferably a plurality of, sensor assemblies (100) may be arranged for example approximately parallel to each other on a delimitation element (310), wherein the sensor elements that may be so arranged in a plane may form a sensor matrix.

At least one separating element, preferably plural separating elements (330), may be arranged on, respectively, at least two delimitation elements (310), which may oppose each other and thus are aligned approximately parallel to each other, wherein the separating elements (330) may run transversely to the delimitation elements (310), such that at least two, preferably a plurality of, surveillance spaces (Rn) may be formed.

At least one fixing device (325) for at least one separating element (330) may be present for example on at least one delimitation element (310) on at least one outer surface (311).

A plurality of fixing devices (325) may be arranged for example on at least one side of a delimitation element (310), such that a variable sub-divisioning (or sub-dividing) of the surveillance space (R) may be possible.

For example, at least one signal transducer (21) and one signal receiver (22) may be assigned to each surveillance space (Rn).

The storing device (300) may be for example a shelf unit (or rack) (400), and at least one first delimitation element (310) may form a shelf (410).

For example, further delimitation elements (310), respectively, may form further shelf unit planes (RE) in the shelf unit (400), wherein the space between two respective shelf unit planes (RE)(a), (RE)(b) may form at least one surveillance space (R).

For example, the at least one sensor assembly (100) may be arranged, according to gravity (F), below the respective shelf (410) of a shelf unit plane (RE).

For example, sensor elements (20) of different shelf unit planes (RE) may be aligned, respectively according to their respective position in the sensor assembly (100) approximately on a common axis (A), wherein the axis (A) may run vertically according to the gravity (F).

Sensor elements (20) of different shelf unit planes (RE) may be oriented, respectively, for example according to their respective type, in only one direction (OR), in particular all signal transducers (21) of different planes may be oriented only in a first direction (OR)(21) and that all signal receivers (22) of different planes may be oriented only in a second direction (OR)(22).

For example, all signal transducers (21) may be, according to the gravitation (F), oriented from the top to the bottom, and all signal receivers (22) may be oriented oppositely from the bottom to the top.

The shelf of respectively one shelf unit plane (RE) may have, in at least one direction, a slope (or an inclination) for example with respect to the horizontal plane (E) in space.

The storage device (300) may be for example a cupboard (500) having at least one drawer (501), wherein at least two mutually opposing side walls (510) of the drawer, as delimitation elements (310)(a), (310)(b), at least partially may enclose a surveillance space (R).

At least one sensor assembly (100) may be for example integrated in at least one delimitation element forming a side wall.

For example, sensor elements (20) of different delimitation elements (310) may be oriented, respectively, according to their respective position on the sensor assembly (100) approximately on a common axis (A), wherein the axis (A) may run transverse and approximately horizontally to the gravitation (F).

For example, sensor elements (20) of different delimitation elements may be oriented, respectively, according to their respective type, in only one direction (OR), in particular all signal transducers (21) of different delimitation elements may be oriented only in a first direction (OR21) and that all signal receivers (22) of different delimitation elements may be oriented only in a second direction (OR22).

All signal transducers (21) may be oriented from the backside wall to the frontside wall according to the pulling-out direction of the drawer (501), and all signal receivers (22) may be oriented oppositely from the frontside wall to the backside wall.

For example, at least one further delimitation element (310c), which may be arranged transverse to the pulling-out direction of the drawer (501), may be provided.

For example, at least one separating element (330), which may be arranged parallel to the pulling-out direction of the drawer (501), may be provided.

The drawer (501) may have for example a drawer plug connector (523), which may connect the drawer (501) at least in the closed state electrically to a power supply and/or to a data line in the corpus of the cupboard (500).

For example, a control unit (360) may query at least one occupancy state (BZ) of at least one surveillance space (R) or of a part of a sub-divided surveillance space (TB), and may evaluate the result and/or may transmit this further to a superordinate management system (660).

For example, the control unit (360) may manage logically at least respectively two co-operating sensor elements (20) of at least two different sensor assemblies (100) or at least subsets of co-operating sensor matrices, and thus may define a logical partial section (TB), which may extend in a plane along an extension direction of a first sensor assembly and/or transversely to the extension direction of a first sensor assembly over at least one further sensor assembly arranged in parallel.

For example, at least one logical partial section (or sub-section) may correspond to precisely one unit of a storage good (G) to be stored.

For example, at least one logical partial section (TB) may correspond to at least one arrangement of delimitation elements (310) and/or separating elements (330), in particular may correspond to the size of at least one partial section (TB) formed by delimitation elements (310) and/or separating elements (330).

The control unit (360) may detect for example during an initialization process the partial sections (TB) on the basis of the arrangement of the delimitation elements (310) and/or the separating elements (330) among each other, and may correspondingly define at least one surveillance space (R) in its logical partial sections (TB), and may store [them] in the management system (660).

### LIST OF REFERENCE NUMERALS

100 sensor assembly
10 carrier element
11 outer surface
12 outer surface
13 outer surface
14 outer surface
15 conductor path
16 control electronics
20 sensor element
21 signal transducing device (or signal transducer)
22 signal receiving device (or signal receiver)
23 electric/electronic components
24 data bus
25 power supply
26 test signal transducing device
30 adhesion surface
31 covering film
32 protective layer/protective film
40 marking/fixation
200 sensor system
260 control electronics
270 communication device
300 storage device
310 delimitation element
311 a, b, c, d, e, f outer surfaces of the delimitation element
315 signal opening for conveying signals
316 recess
317 insertion opening
318 cavity
321 section of the delimitation element
322 section of the delimitation element
325 fixing device for separating element
326 contact of fixing device
327 power line and data line
330 separating element
360 control unit
400 shelf unit (or rack)
410 shelf (or floor sheet)
500 cupboard
501 drawer
510 a, b, c, d side walls
523 drawer plug connector
524 data bus
525 power supply
600 storage system
620 data bus
630 communication device
640 network connection
650 server
660 management system
670 hand-held scanner
680 optically readable code
690 signalling means
700 occupancy plan
710 occupancy information
720 remote maintenance module
730 computer
A axis
B reference point
BZ occupancy state
E plane
F gravity (or gravitation)
G storage good/piece good
OR orientation
R surveillance space
S signal
TB partial section

1. A storage system having at least one shelf unit, the shelf unit having shelves arranged on top of each other, wherein each shelf is logically subdivided in compartments arranged side by side, wherein a unique address is assigned to each of the compartments, and having a sensor system for detecting an occupancy of the compartments, wherein the sensor system is configured to spatially scan the occupancy of one of the compartments to generate an occupancy information, which indicates a degree of occupancy of the respective compartment, and having a data bus, which is connected to the sensor system and a communication device, wherein the storage system is configured to perform the following steps:
detecting an occupancy information of the compartments by the sensor system,
transmitting the occupancy information together with the address assigned to the compartment, from which the occupancy information has been detected, from the sensor system via the data bus to the communication device, and
establishing a network connection by the communication device to transmit occupancy information to a server or control information to the storage system in a unidirectional or bidirectional communication.

2. The storage system according to claim 1, wherein the shelves have are inclined with a slope in the direction towards a withdrawal side of the shelf unit.

3. The storage system according to claim 1, wherein the sensor system has sensor assemblies, and each of the sensor assemblies is assigned to one of the compartments, wherein a sensor assembly has a number of sensor elements arranged in a longitudinal direction of the sensor assembly.

4. The storage system according to claim 3, wherein each sensor assembly is assigned uniquely to precisely one compartment, and the longitudinal direction of the sensor assembly runs in the direction of the slope of the compartments.

5. The storage system according to claim 3, wherein a sensor assembly has a strip-shaped, flexible or rigid conductor board as a carrier.

6. The storage system of claim 3, wherein a sensor assembly is fixed to the lower side of the shelf, by which the compartment, which is assigned to the respective sensor assembly, is formed.

7. The storage system of claim 3, having a control electronics for each of the sensor assemblies, wherein the control electronics is configured to connect the sensor assembly to the data bus as well as to output the address assigned to the compartment and the occupancy information onto the data bus.

8. The storage system according to claim 1, wherein at least one optical signal means is uniquely assigned to each of the compartments, wherein the optical signal means is connected to the data bus so as to receive, via the data bus, a signal for optically indexing a compartment, and to realize the optical indexing.

9. The storage system according to claim 1, wherein the storage system is configured to store a stock-taking point in time and an automatic stock-taking is performed upon reaching the stock-taking point in time.

10. The storage system according to claim 1, wherein an occupancy plan is stored in the communication device, in which occupancy plan an assignment of goods types respectively to one or addresses and/or compartments, and a threshold value for the occupancy quantity of goods of respectively one goods type is stored,
wherein the communication device is configured such that the quantity of goods of each goods type, which quantity is placed into stock in the storage system, can be determined from the occupancy information received via the data bus and the respective assigned addresses, and that the determined quantity of goods of each goods type can be compared with the quantity threshold value assigned to this goods type, and a signal can be sent, if the determined quantity of goods of this goods type falls below the quantity threshold value assigned to this goods type.

11. The storage system according to claim 1, wherein a remote maintenance program module is installed on the communication device, which remote maintenance program module is addressable via the network and can perform maintenance operations directly on the storage system, wherein the remote maintenance program module is configured such that upon a receipt of a command via the network, the sensor system is activated such that the occupancy information of a compartment, which is specified in the command by the indication of an according address, is measured, and on the basis of the occupancy information, an occupancy information signal is generated, which is sent via the network.

12. The storage system according to claim 1, wherein the communication device can dynamically store occupancy information of the storage system, such that in the case of a system failure, the occupancy information can be restored at any time and can be used again upon a new system availability.

13. The storage system according to claim 1, wherein the communication device is configured to connect to a computer via a local connection so as to visualize an occupancy plan, which is stored in the communication device, on a user interface of the computer.

14. The storage system according to claim 1, wherein the communication device has a setup mode, wherein an occupancy of the storage system, which occupancy has been measured by the sensor system in the setup mode, can be stored as an occupancy plan, wherein the occupancy plan comprises in particular a goods type assigned to each one of the compartments, and an occupancy threshold value, which is assigned to the goods type, and which is given by the occupancy measured by the sensor system,
wherein the storage system further has
a hand-held scanner for optically recognizing an optically readable code, wherein each one of the compartments carries an optically readable code indicating the respective address, wherein the communication device is configured such that the assignment of a goods type to one or more of the compartments is effected in that the communication device receives an optically measured address from the hand-held scanner, and a goods type assigned to the optically measured address,
wherein further the hand-held scanner is configured wirelessly and has a wireless communication interface for communication with the communication device.

15.-16. (canceled)

17. The storage system according to claim 1, wherein the sensor system has one sensor assembly per compartment as a flexible, strip-shaped conductor board
implemented in one of the following embodiments:
(i) wherein the sensor assemblies are fixed respectively at the lower side of a shelf such that the signal transducers of one of the sensor assemblies can irradiate a signal in the direction towards the upper side of the shelf, which is arranged respectively one level lower, and the signal receivers of one of the sensor assemblies can receive a signal from the shelf, which is arranged respectively one level above, through an opening located in the shelf,
(ii) wherein the signal transducer and the signal receiver of a sensor assembly are arranged in pairs on the conductor board such that a signal, which is output from one of the signal transducers, can be received by a signal receiver of the same pair,
(iii) wherein the signal transducers and the signal receivers of a sensor assembly are arranged in pairs directly adjacently, wherein the arranged signal transducers and signal receivers are assigned respectively to an opening located in the shelf such that a signal transmitted by one of the signal transducers can be sent and received through the opening by a signal receiver of the same pair,
(iv) wherein the signal transducers, the signal receivers and/or conductor paths are printed on the conductor board for the interconnection of the signal receivers and the signal transducers to the data bus.

18.-21. (canceled)

22. The storage system according to claim 1, wherein the shelves have openings in the filling direction of the compartments to enable a receipt of a signal and/or a signal transmission by the sensor system, wherein the sensor assemblies of the sensor system are arranged underneath the shelves, and having a film, which is applied in the filling direction on an upper side of the shelf, and which covers the openings,
wherein the film is transparent in a range of a frequency of a received signal and/or of the signal transmission.

23. (canceled)

24. A method for setting up a storage system, the method comprising:
switching a communication device in a setup mode,
occupying the compartments of the storage system according to a predefined occupancy plan, with minimum stock quantities, underneath which repeat orders shall be triggered,
detecting the minimum stock quantities by a sensor system and storing them in a communication device, and
completing the occupancy to a nominal stock in the storage system.

25. The method according to claim 24,
wherein an assignment of a goods type to one of the compartments is effected by a hand-held scanner, or
wherein a hand-held scanner has a wireless communication interface to the communication device to transmit to the communication device an assignment signal for assigning the goods type to one of the compartments.

26. (canceled)

27. The method according to claim 24, further comprising:
detecting occupancy information of at least one of the compartments,
comparing, by the communication device the detected occupancy information to a stored occupancy plan,
if a discrepancy between the detected occupancy information and the occupancy plan is detected by the communication device, generating, by the communication device, a false occupancy signal, and sending the false occupancy signal via a data bus to an address of a sensor assembly, from which the occupancy information has been detected.

28. The method according to claim 27, wherein an optical signaling means connected to the data bus via the sensor assembly, and an electronic control of the sensor assembly, which receives the false occupancy signal from the communication device via the data bus, activates the optical signaling means of the respective sensor assembly for outputting the false occupancy signal.
